(19) United States
(12) Patent Application Publication
(10) Pub. No.: US 2010/0329447 A1
(43) Pub. Date: Dec. 30, 2010

(54) ENCRYPTION APPARATUS, DECRYPTION APPARATUS, KEY GENERATION APPARATUS, AND PROGRAM

(76) Inventors: Koichiro Akiyama, Tokyo (JP); Yasuhiro Goto, Hakodate-shi (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/266,027

(22) Filed: Nov. 6, 2008

(30) Foreign Application Priority Data
Nov. 8, 2007 (JP) 2007-291013

(51) Int. Cl. H04L 9/28

(52) U.S. Cl. 380/28

(57) ABSTRACT

An encryption apparatus includes a plaintext embedding unit that embeds a message m as a coefficient of a three-variable plaintext polynomial m(x,y,t), an identification polynomial generating unit that generates a three-variable identification polynomial f(x,y,t), a polynomial generating unit that randomly generates three-variable polynomials r₁(x,y,t), r₂(x,y,t), s₁(x,y,t), and s₂(x,y,t), and an encrypting unit that generates encrypted texts F₁ and F₂ by performing an arithmetic operation with respect to these three-variable polynomials.

### CROSS-REFERENCE TO RELATED APPLICATIONS

This application is based upon and claims the benefit of priority from prior Japanese Patent Application No. 2007-291013, filed Nov. 8, 2007, the entire contents of which are incorporated herein by reference.

### BACKGROUND OF THE INVENTION

1. Field of the Invention

The present invention relates to an encryption apparatus, a decryption apparatus, a key generation apparatus, and a program used in a public key encryption system.

2. Description of the Related Art

In a network society, transmitting many pieces of information, e.g., electronic mails in the network enables effecting people's communication. In such a network society, public key cryptography is widely exploited as a technology that protects confidentiality or authenticity of information.

As typical public key cryptography systems, there are RSA cryptography and elliptic curve cryptosystems. Since general decryption methods for these public key cryptographies are not known, no serious problems concerning security exist, except for a later-explained decryption method using a quantum computer. As other public key cryptographies, there are a knapsack encryption, a multivariate encryption, and others. However, since there is a decryption method for knapsack encryption, the security of this encryption has been called into question. To counter this, a key size in multivariate encryption is increased, and hence a prevailing attacking method can be avoided. However, this encryption has a problem that the key size becomes enormous.

On the other hand, if a quantum computer were to be used, it would be possible to decrypt RSA cryptography and that of the elliptic curve cryptosystem. Being different from current computers, the quantum computer is a computer that can utilize a physical phenomenon called entanglement in quantum theory to execute a huge number of parallel computations. The quantum computer is an ideal computer on an experimental level, and it has been studied and developed toward realization. In 1994, Shor demonstrated that a quantum computer can efficiently solve factorization into prime factors or a discrete logarithm problem. Therefore, if the quantum computer is realized, it will become possible to decrypt RSA cryptography based on factorization into prime factors or the elliptic curve cryptosystem based on a discrete logarithm problem on an elliptic curve.

On the other hand, there has been studied a public key cryptography system that is safe even if a quantum computer is realized. For example, there is quantum public key cryptography. In the quantum public key cryptography, a quantum computer generates a key for the knapsack encryption that is secure so that the key cannot be produced by a current computer. Therefore, in the quantum public key cryptography, a secure knapsack encryption that cannot be calculated by a quantum computer can be constituted. However, in the quantum public key cryptography, a current computer cannot generate its key, and hence this cryptography cannot be utilized at the present day.

On the other hand, the multivariate encryption can be realized even in the present day, and even a quantum computer cannot decrypt this system. However, since the multivariate encryption requires a massive key size, as explained above, the realization of this encryption is questionable.

Further, as compared with a symmetric key cryptography, the public key cryptography has a larger circuit scale and a longer processing time. Therefore, there is a problem that the public key cryptography cannot be realized in a low-power environment, e.g., a mobile terminal, or a waiting time is long even if it is realized. Therefore, public key cryptography that can be realized even in a low-power environment has been demanded.

In general, the public key cryptography is configured to be equivalent to finding a problem that is difficult to calculate, e.g., a prime factorization problem or a discrete logarithm problem in advance and solving the problem that is difficult to calculate when trying to decrypt an encrypted text without knowing a private key.

However, even if a problem that is difficult to calculate is found, public key cryptography having this problem as a basis for security cannot be readily constituted. That is because a problem that generates a key also becomes difficult when a problem that is too difficult to calculate is a basis for security, and hence the key cannot be produced. On the other hand, when a problem allows easy generation of a key, decryption also becomes easy.

Therefore, in order to constitute public key cryptography, a problem that is difficult to calculate must be found, and the found problem must be remade into a problem having an adequate balance so that a key can be readily generated but cannot be easily decrypted. Such remake of a problem requires high creativity. Actually, remaking a problem is very difficult, and hence only a few public key cryptographies have been proposed.

Under such a situation, there is a possibility that even a quantum computer cannot efficiently perform decryption. As a public key cryptography system that can perform processing at a high speed even in a low-power environment, public key cryptography using an algebraic curve has been proposed (see, e.g., JP-A 2005-331656 (KOKAI)).

The public key cryptography system that uses an algebraic curve is explained below. That is, a private key is determined as two sections corresponding to an algebraic curve X (x,y,t), and a public key is determined as an algebraic curve X (x,y,t). At this time, an encrypted text F=Eₚₖ(m,s,r,f,X) is generated from a plaintext polynomial m(t) based on processing of embedding a plaintext m in the plaintext polynomial m(t), processing of randomly generating a one-variable irreducible polynomial f(t) having a degree L, processing of generating randomized polynomials s(x,y,t) and r(x,y,t) having three variable x, y, and t, and processing of calculating respective polynomials s(x,y,t), r(x,y,t), and f(t) and a definitional equation X(x,y,t). According to this system, a later-explained section finding problem on an algebraic surface is a basis for security, and hence decryption is difficult.

However, in the above-explained public key cryptography using an algebraic surface, both the plaintext polynomial m(t) and the irreducible polynomial f(t) are one-variable polynomials. Therefore, decryption may be possible if an attacker aggressively utilizes the fact that secrecy is hidden in the one-variable polynomials, and there is vulnerability in this sense.

### BRIEF SUMMARY OF THE INVENTION

In a first aspect of the present invention, there is provided an encryption apparatus comprising: a plaintext embedding device configured to embed a message m as a coefficient of a plaintext polynomial m(x,y,t) having three variables when encrypting the message m if a fibration X(x,y,t) of an algebraic surface X is a public key and two or more sections corresponding to the fibration X(x,y,t) are private keys; an identification polynomial generation device configured to generate an identification polynomial f(x,y,t) having three variables in such a manner that a degree of a one-variable polynomial obtained when assigning the sections becomes higher than a degree of a one-variable polynomial obtained by assigning the sections to the plaintext polynomial; a polynomial generation device configured to randomly generate three-variable polynomials r₁(x,y,t), r₂(x,y,t), s₁(x,y,t), and s₂(x,y,t); a first encryption device configured to generate a first encrypted text F₁=Eₚₖ(m,s₁,r₁,f,X) from the plaintext polynomial m(x,y,t) by processing of executing addition or subtraction using a multiplication result f(x,y,t)s₁(x,y,t) of the identification polynomial f(x,y,t) and the polynomial s₁(x,y,t) and a multiplication result X(x,y,t)r₁(x,y,t) of the fibration X(x,y,t) and the polynomial r₁(x,y,t); and a second encryption device configured to generate a second encrypted text F₂=Eₚₖ(m,s₂,r₂,f,X) from the plaintext polynomial m(x,y,t) by processing of executing addition or subtraction using a multiplication result f(x,y,t)s₂(x,y,t) of the identification polynomial f(x,y,t) and the polynomial s₂(x,y,t) and a multiplication result X(x,y,t)r₂(x,y,t) of the fibration X(x,y,t) and the polynomial r₂(x,y,t).

In a second aspect of the present invention, there is provided a decryption apparatus comprising: a first input device configured to input a first encrypted text F₁(x,y,t)=Eₚₖ(m,s₁,r₁,f,X) generated by processing of executing addition or subtraction using a multiplication result f(x,y,t)s₁(x,y,t) of a three-variable identification polynomial f(x,y,t) and a polynomial s₁(x,y,t) and a multiplication result X(x,y,t)r₁(x,y,t) of a fibration X(x,y,t) and a polynomial r₁(x,y,t) with respect to a three-variable plaintext polynomial m(x,y,t) in which a message m is embedded as a coefficient thereof in case of decrypting the message m from the first and second encrypted texts F₁(x,y,t) and F₂(x,y,t) generated by using a public key as the fibration X(x,y,t) based on a private key as one or more sections corresponding to the fibration X(x,y,t) of an algebraic surface X; a second input device configured to input the second encrypted text F₂(x,y,t)=Eₚₖ(m,s₂,r₂,f,X) generated by processing of executing addition or subtraction using a multiplication result f(x,y,t)s₂(x,y,t) of the three-variable identification polynomial f(x,y,t) and a polynomial s₂(x,y,t) and a multiplication result X(x,y,t)r₂(x,y,t) of the fibration X(x,y,t) and a polynomial r₂(x,y,t) with respect to the plaintext polynomial m(x,y,t); a section assignment device configured to assign the respective sections to the input respective encrypted texts F₁(x,y,t) and F₂(x,y,t) to generate two one-variable polynomials h₁(t) and h₂(t); a polynomial subtraction device configured to subtract the respective one-variable polynomials h₁(t) and h₂(t) to obtain a subtraction result {h₁(t)−h₂(t)}; a factorization device configured to factorize the subtraction result {h₁(t)−h₂(t)}; a polynomial extraction device configured to extract all identification polynomial candidates f(uₓ,(t),u_{y}(t),t) each precisely having a degree deg f(uₓ(t),u_{y}(t),t) by combining factors generated as a result of the factorization; a residue arithmetic device configured to divide the one-variable polynomial h₁(t) by each identification polynomial candidate f(uₓ,(t),u_{y}(t),t) to obtain a plaintext polynomial candidate m(uₓ,(t),u_{y}(t),t) as a residue; a plaintext candidate generation device configured to derive a linear simultaneous equation having a coefficient of the plaintext polynomial m(x,y,t) as a variable based on the plaintext polynomial candidate f(uₓ,(t),u_{y}(t),t) and a previously disclosed format of the plaintext polynomial m(x,y,t) and solve the linear simultaneous equation to generate a plaintext candidate M; a plaintext polynomial inspection device configured to inspect whether the polynomial candidate M is a true plaintext based on an error detection code included therein; and an output device configured to output the plaintext candidate M as a plaintext when the plaintext candidate M as the true plaintext is present as a result of the inspection.

In a third aspect of the present invention, there is provided a key generation apparatus comprising: a section generation device configured to randomly generate one or more sections, the sections being private keys corresponding to a fibration X(x,y,t) of an algebraic surface X when the sections are private keys; a coefficient generation device configured to randomly generating a coefficient of a term other than a constant term when the fibration X(x,y,t) is regarded as a polynomial of variables x and y and thereby produce the term other than the constant term in a case where the fibration X(x,y,t) is a public key; a fibration generation device configured to calculate the constant term by giving a negative sign to an assignment result obtained by assigning the sections to the term other than the constant term and generate the fibration X(x,y,t) constituted of the term other than the constant term and the constant term; a section assignment device configured to assign the sections to a basic format of a plaintext polynomial having a coefficient mᵢⱼₖ as a variable when generating a format of the plaintext polynomial in which a message m is embedded; a device configured to sequence each variable mᵢⱼₖ obtained as a result of the assignment to generate a variable vector (m₀₀₀, m₀₀₁, . . . , mᵢⱼₖ, . . . ); a coefficient extraction device configured to organize each one-variable polynomial m(uₓ(t),u_{y}(t),t) obtained as a result of the assignment in regard to t to extract a polynomial having a coefficient mᵢⱼₖuₓ(t)ⁱu_{y}(t)^{j} of t; a coefficient matrix generation device configured to generate a coefficient matrix in such a manner that a product obtained from the variable vector (m₀₀₀, m₀₀₁, . . . , mᵢⱼₖ, . . . ) precisely becomes the coefficient mᵢⱼₖuₓ(t)ⁱu_{y}(t)^{j} of t; a coefficient matrix calculation device configured to calculate a rank of the coefficient matrix; a variable adjustment device configured to set the variables mᵢⱼₖ in some of the one-variable polynomials m(uₓ(t),u_{y}(t),t) to constants when the rank is higher than a degree number of the variable vector; and an output device configured to output a format of a three-variable polynomial m(x,y,t) corresponding to the one-variable polynomial m(uₓ(t),u_{y}(t),t) when the rank is equal to or lower than the degree number of the variable vector as a format of the plaintext polynomial.

In the first and second aspects, as different from the conventional technology utilizing the plaintext polynomial m(t) and the irreducible polynomial f(t) each having one variable, the plaintext polynomial m(x,y,t) and the identification polynomial f(x,y,t) each having three variables are used.

In the third aspect, as different from the conventional technology utilizing the plaintext polynomial m(t) having one variable, the plaintext polynomial m(x,y,t) having three variables is used.

Therefore, according to the first to third aspects, it is possible to eliminate weakness caused due to one-variable polynomials in the public key cryptography system using an algebraic surface.

### BRIEF DESCRIPTION OF THE SEVERAL VIEWS OF THE DRAWING

FIG. 1 is a schematic view for explaining a general algebraic curve;

FIG. 2 is an entire block diagram of an encryption apparatus according to an embodiment;

FIG. 3 is an entire block diagram of a decryption apparatus according to the embodiment;

FIG. 4 is an entire block diagram of a key generation apparatus according to the embodiment;

FIG. 5 is a flowchart of the encryption apparatus according to the embodiment;

FIG. 6 is a flowchart of the decryption apparatus according to the embodiment; and

FIGS. 7 and 8 are flowcharts of the key generation apparatus according to the embodiment.

### DETAILED DESCRIPTION OF THE INVENTION

Each embodiment according to the present invention will now be described with reference to the accompanying drawings.

An algebraic surface in each embodiment is defined as one having a two-dimensional freedom degree in a set of solutions of a simultaneous (algebraic) equation defined in a field K. For example, since a simultaneous equation in the field K represented as the following Expression (1) has three equations that constrain five variables, it has a two-dimensional freedom degree, and hence it is an algebraic surface.

$$\{ \begin{matrix}{f}_{1} ( x , y , z , v , w ) = 0 \\ {f}_{2} ( x , y , z , v , w ) = 0 \\ {f}_{3} ( x , y , z , v , w ) = 0\end{matrix} \qquad ( 1 )$$

In particular, as represented by Expression (2), a space defined as a set of solutions of an algebraic equation in the field K having three variables is also an algebraic surface in the field K.

f(x,y,z)=0 (2)

It is to be noted that a definitional equation of the algebraic surface represented by Expressions (1) and (2) is an equation in an affine space. A definitional equation of an algebraic surface in a projective space (in case of Expression (2)) is f(x,y,z,w)=0.

However, in each embodiment, the algebraic surface is not processed in the projective space, and hence a definitional equation of the algebraic surface is determined as Expression (1) or Expression (2). However, even if this definitional equation is expressed in the projective space, each embodiment can be achieved as it is.

On the other hand, an algebraic curve is one having a one-dimensional freedom degree in a set of solutions of a simultaneous (algebraic) equation defined in the field K. Therefore, the algebraic curve is defined by, e.g., the following expression.

g(x,y)=0

In this embodiment, since an algebraic surface that can be written in one expression like Expression (2) is used, Expression (2) is used like a definitional equation of the algebraic surface in the following explanation.

The field is a set in which addition, subtraction, multiplication, and division can be freely carried out. A real number, a rational number, and a complex number correspond to the field. A set including an element that cannot be divided except by zero, e.g., the set of integer or the set of matrix does not correspond to the field. In fields, there is a field constituted of a finite number of elements called a finite field. For example, a residue class Z/pZ having a modulo p with respect to a prime number p forms a field. Such a field is called a prime field, and written as Fₚ or the like. As finite fields, there is, e.g., a field Fq(q=p^{r}) having elements obtained by raising a prime number. However, in this embodiment, a prime field Fₚ alone is mainly used for the sake of convenience. In general, p in the prime field Fₚ is called a characteristic of the prime field Fₚ.

On the other hand, even in the case of coping with a general finite field, each embodiment can be likewise achieved by carrying out a self-evident modification. It is often the case that public key cryptography is constituted in a finite field because a message is embedded as digital data. In this embodiment, likewise, an algebraic surface defined in a finite field (a prime field in particular in this embodiment) Fₚ is used.

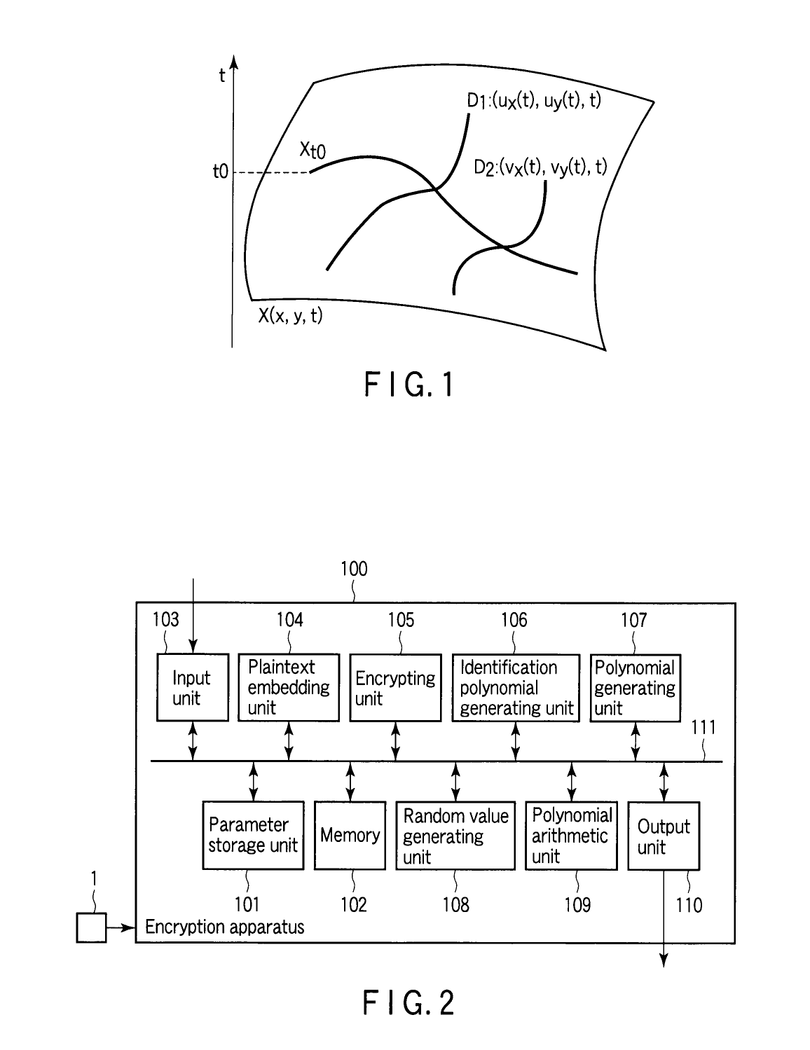

As shown in FIG. 1, a plurality of algebraic curves are usually present on an algebraic surface f(x,y,z)=0. Such an algebraic curve is called a factor on an algebraic surface.

In general, a problem of finding a (non-self-evident) divisor when a definitional equation of an algebraic surface is given is a difficult problem that is unsolvable even in contemporary mathematics. Except for a primitive method, e.g., solving such a system of multivariate equations as described later or a round-robin solution, a general solving method is unknown. In particular, in an algebraic surface defined by such a finite field as used in this embodiment, there are not so many clues as compared with an infinite field (a field constituted of infinite number of elements), e.g., a rational number field, and it is known that it is a very difficult problem.

In this embodiment, this problem is called a divisor finding problem on an algebraic surface or simply a divisor finding problem, and a public key cryptography system having a divisor finding problem on an algebraic surface as a basis for security is constituted.

Next, on an algebraic surface X:f(x,y,z)=0 in a field K, x and y are defined by the following expression and called sections:

h(x,y,t)=0

An algebraic curve expressed in a form in which a curve represented by the following expression obtained by parameterizing x,y with t exists is called a fibration of an algebraic surface X and expressed as Xₜ or the like:

(x,y,t)=(uₓ(t),u_{y}(t),t)

It is to be noted that since a fibration is apparent in the following explanation, such an algebraic surface is simply represented as X.

Further, an algebraic surface obtained by assigning an element t0 of the field K to a parameter t is called a fiber and expressed as, e.g., Xₜ₀. Both the fiber and the section are divisors of the algebraic surface Xₜ.

In general, when a fibration of an algebraic surface is given, a corresponding fiber can be immediately obtained (by assigning an element of a field to t). However, finding a corresponding section is very difficult. Therefore, it can be said that the fiber is a trivial divisor and the section is a non-trivial divisor.

A public key cryptography system in each embodiment determines a problem of obtaining a section as a basis for security when especially a fibration Xₜ of an algebraic surface X is given in a problem of finding divisors on an algebraic surface.

In order to obtain a section from a fibration, only a method based on the following procedure from (i) to (iv) is known even in contemporary mathematics.

(i) A section (uₓ(t), u_{y}(t),t) is assumed as deg uₓ(t)<rₓ, deg u_{y}(t)<r_{y}, and uₓ(t) and u_{y}(t) are then set, as in the following expressions:

uₓ(t)=α₀+α₁t+ . . . +αᵣ_{ₓ}₋₁t^{r}^{ₓ}⁻¹

u_{y}(t)=β₀+β₁t+ . . . +βᵣ_{_{y}}₋₁t^{r}^{_{y}}⁻¹

(ii) uₓ(t) and u_{y}(t) are assigned to X(x,y,t)=to obtain the following expression:

$$X ( {u}_{x} ( t ) , {u}_{y} ( t ) , t ) = {\sum }_{i} {c}_{i} {t}^{i} = 0$$

(iii) The left-hand side of the above expression is developed to express a coefficient of tᵢ by using a function cᵢ(α₀, . . . , αᵣ_{ₓ}₋₁,β₀, . . . , βᵣ_{_{y}}₋₁) of α₀, . . . , αᵣ_{ₓ}₋₁,β₀, . . . , βᵣ_{_{y}}₋₁, thereby achieving the following the system of multivariate equations:

$$\{ \begin{matrix}{c}_{0} ( {α}_{0} , … , {α}_{{r}_{x} - 1} , {β}_{0} , … , {β}_{{r}_{y} - 1} ) = 0 \\ {c}_{1} ( {α}_{0} , … , {α}_{{r}_{x} - 1} , {β}_{0} , … , {β}_{{r}_{y} - 1} ) = 0 \\ ⋮ \\ {c}_{{r}_{x} + {r}_{y} - 2} ( {α}_{0} , … , {α}_{{r}_{x} - 1} , {β}_{0} , … , {β}_{{r}_{y} - 1} ) = 0\end{matrix}$$

(iv) The system of equations is solved.

Public key cryptography according to this embodiment based on a problem of finding sections on an algebraic surface will now be described specifically.

### First Embodiment

### Outline

Public key cryptography according to this embodiment has the following two system parameters p and d.

1. A size of a finite field: p
2. A maximum degree of a section (as a private key):

d=max{deg uₓ(t),deg u_{y}(t)} (3)

Further, the public key corresponds to each of the following three items.

1. A Fibration of an algebraic surface X on Fₚ:

$$X ( x , y , t ) = {\sum }_{( i , j ) ∈ {Λ}_{X}} {a}_{ij} ( t ) {x}^{i} {y}^{j}$$

2. A format of a plaintext polynomial:

$$m ( x , y , t ) = {\sum }_{( i , j ) ∈ {Λ}_{m}} {m}_{ij} ( t ) {x}^{i} {y}^{j}$$

3. A format of an identification polynomial:

$$f ( x , y , t ) = {\sum }_{( i , j ) ∈ {Λ}_{f}} {f}_{ij} ( t ) {x}^{i} {y}^{j}$$

Here, Λ_{A} means a set of combinations of an index i of x and an index j of y having a non-zero coefficient when a polynomial A(x,y,t) is regarded as a polynomial of x and y. Furthermore, these formats are constituted of sets Λₘ and Λ_{f} and degrees deg mᵢⱼ(t) and deg fᵢⱼ(t) of coefficients of respective terms.

The private key is the following section D.

1. A section of the algebraic surface X on Fₚ:

D(x,y,t)=(uₓ(t),u_{y}(t),t).

However, the algebraic surface X as the private key satisfies conditions (4).

degₓX(x,y,t)<degₓm(x,y,t)

deg_{y}X(x,y,t)<deg_{y}m(x,y,t)

degₜX(x,y,t)<degₜm(x,y,t) (4)

The plaintext polynomial and the identification polynomial satisfy conditions (5).

degₓm(x,y,t)<degₓf(x,y,t)

deg_{y}m(x,y,t)<deg_{y}f(x,y,t)

degₜm(x,y,t)<degₜf(x,y,t) (5)

Here, in m(x,y,t) and f(x,y,t), only one term that gives a degree of a right-hand side in each of the inequalities is present, it is the same in all the inequalities. That is, taking f(x,y,t) as an example, the following term alone is present in f(x,y,t).

cx^{deg}^{ₓ}^{f(x,y,t)}y^{deg}^{_{y}}^{f(x,y,t)}t^{deg}^{ₜ}^{f(x,y,t)}

Here, c is a source of the finite field Fₚ.

They can be readily obtained by a later-explained method (a key generation method).

An outline of encryption processing will now be explained. In the encryption processing, a message that should be encrypted (which will be referred to as a plaintext hereinafter) is divided to into blocks to provide m=m₀₀∥m₁₀∥ . . . ∥mᵢⱼ It is to be noted that ∥ means a junction. Here, assuming that L=deg mᵢⱼ(t),|mᵢⱼ|≦(|p|−1)(L+1) is determined, and a coefficient mᵢⱼₖ of t^{k} in mᵢⱼ(t) is obtained by dividing mᵢⱼ every |p|−1 bits. That is, the following expression can be achieved.

mᵢⱼ=mᵢⱼ₀∥mᵢⱼ₁∥ . . . ∥m_{ijL}

Here, |p| represents a bit length of p. In this manner, the plaintext is embedded in a plaintext polynomial m(x,y,t) shown in the following expression.

$$m ( x , y , t ) = {\sum }_{( i , j ) ∈ {Λ}_{m}} {m}_{ij} ( t ) {x}^{i} {y}^{j}$$

Incidentally, it is assumed that a message according to this embodiment includes an error detection code. The error detection code has a function of detecting that a message is partially mutilated due to, e.g., noise produced in transmission. As the error detection code, a hash value based on a hash function may be taken.

Then, the identification polynomial f(x,y,t) on Fₚ is randomly generated in a format satisfying the conditions (5). Subsequently, polynomials r₁(x,y,t), r₂(x,y,t), s₁(x,y,t), and s₂(x,y,t) are randomly generated to calculate two encrypted texts F₁(x,y,t) and F₂(x,y,t) from polynomials m(x,y,t) and f(x,y,t) each having three variables and the fibration X(x,y,t) of the algebraic surface X.

F₁(x,y,t)=m(x,y,t)+f(x,y,t)s₁(x,y,t)+X(x,y,t)r₁(x,y,t)

F₂(x,y,t)=m(x,y,t)+f(x,y,t)s₂(x,y,t)+X(x,y,t)r₂(x,y,t) (6)

In each embodiment, since each of the plaintext polynomial and the identification polynomial has three variables in light of safety, the two encrypted texts are provided for corresponding decryption processing.

A receiver who has received the encrypted texts F₁(x,y,t) and F₂(x,y,t) utilizes a private key D to perform decryption as follows. First, the section D is assigned to the F(x,y,t). Here, the section D is assigned to the algebraic surface X(x,y,t).

Attention is paid to a fact that a relationship represented by the following expression holds.

X(uₓ(t),u_{y}(t),t)=0

Then, it can be understood that two expressions h₁(t) and h₂(t) having a relationship represented by the following equations can be obtained.

$$\begin{matrix}{h}_{1} ( t ) = {F}_{1} ( {u}_{x} ( t ) , {u}_{y} ( t ) , t ) \\ = m ( {u}_{x} ( t ) , {u}_{y} ( t ) , t ) + f ( {u}_{x} ( t ) , {u}_{y} ( t ) , t ) {s}_{1} ( {u}_{x} ( t ) , {u}_{y} ( t ) , t ) \\ {h}_{2} ( t ) = {F}_{2} ( {u}_{x} ( t ) , {u}_{y} ( t ) , t ) \\ = m ( {u}_{x} ( t ) , {u}_{y} ( t ) , t ) + f ( {u}_{x} ( t ) , {u}_{y} ( t ) , t ) {s}_{2} ( {u}_{x} ( t ) , {u}_{y} ( t ) , t )\end{matrix}$$

Then, the two expressions are respectively subjected to subtraction to calculate the following Expression (7).

h₁(t)−h₂(t)=f(uₓ(t),u_{y}(t),t){s₁(uₓ(t),u_{y}(t),t)−s₂(uₓ(t),u_{y}(t),t)} (7)

Then, h1(t)−h2(t) is factorized to obtain a factor f(uₓ(t),u_{y}(t),t). However, since the factor f(uₓ(t),u_{y}(t),t) does not necessarily become an irreducible factor, a plurality of factors must be combined so that a degree precisely becomes deg f(uₓ(t),u_{y}(t),t). Here, although the format of the identification polynomial f(x,y,t) is known as the public key, what identification polynomial has been actually generated and encrypted by a transmitter is unknown. Therefore, there is a possibility that a coefficient of a maximum degree becomes zero and an actual degree becomes smaller than the above-explained degree deg f(uₓ(t),u_{y}(t),t) depending on how f(x,y,t) is taken. However, such a situation does not occur as long as the conditions (5) are satisfied. Its reason will now be explained. First, the section is first assigned to the following term guaranteed in the conditions (5).

cx^{deg}^{ₓ}^{f(x,y,t)}y^{deg}^{_{y}}^{f(x,y,t)}t^{deg}^{ₜ}^{f(x,y,t)}

Then, the following expression can be achieved.

cuₓ(t)^{deg}^{ₓ}^{f(x,y,t)}u_{y}(t)^{deg}^{_{y}}^{f(x,y,t)}t^{deg}^{ₜ}^{f(x,y,t)}

Since a degree of this term is truly larger than degrees of other terms, the coefficient of the maximum degree does not become zero like the above description.

Additionally, combinations of factors with which the degree precisely becomes deg f(uₓ(t),u_{y}(t),t) are not necessarily uniquely determined. Therefore, all possible combinations of factors are subjected to the following processing.

As means for obtaining the factors that may possibly achieve deg f(uₓ(t),u_{y}(t),t), a technique of sequentially acquiring all combinations of factors output based on factorization and extracting combinations with which the degree precisely becomes deg f(uₓ(t),u_{y}(t),t) can be considered. However, in order to execute this means, assuming that the number of the factor is l, 2^{l} combinations are present. Thus, in addition to this technique, combinations with which the degree exceeds deg f(uₓ(t),u_{y}(t),t) are not combined with more factors, thereby enabling extraction in a shorter processing time.

It is to be noted that factorization of h₁(t)−h₂(t) can be processed in a sufficiently effective time since factorization of a one-variable polynomial is easy.

Then, a plaintext polynomial candidate m(uₓ(t),u_{y}(t),t) is obtained as a residue acquired when h₁(t) is divided by an identification polynomial candidate f(uₓ(t),u_{y}(t),t).

m(uₓ(t),u_{y}(t),t)h₁(t)(mod f(uₓ(t),u_{y}(t),t))

Here, since deg m(uₓ(t),u_{y}(t),t)<deg f(uₓ(t),u_{y}(t),t) is achieved based on the conditions (5), it can be understood that correct m(uₓ(t),u_{y}(t),t) can be obtained on the premise that correct f(uₓ(t),u_{y}(t),t) has been acquired.

On the other hand, the coefficient mᵢⱼₖ of the following plaintext polynomial m(x,y,t) is obtained by solving a linear simultaneous equation using this coefficient as a variable.

$${\sum }_{( i , j ) ∈ {Λ}_{m}} {m}_{ij} ( t ) {x}^{i} {y}^{j}$$

Actually, mᵢⱼₖ is determined as a variable, and the following expression is determined.

$$m ( x , y , t ) = {\sum }_{( i , j , k ) ∈ {Γ}_{m}} {m}_{ijk} {{u}_{x} ( t )}^{i} {{u}_{y} ( t )}^{j} {t}^{k}$$

Since the plaintext candidate polynomial m(uₓ(t),u_{y}(t),t) is equal to mᵢⱼₖuₓ(t)ⁱu_{y}(t)^{j}t^{k}, the linear simultaneous equation using mᵢⱼₖ as a variable can be obtained based on comparison of a coefficient of t^{k}. Here, Γ_{A} means a set of combinations of an index i of x, an index j of y, and an index k of t each having a on-zero coefficient when a polynomial A(x,y,t) is regarded as a polynomial of x,y,t.

Actually, t is an only variable except mᵢⱼₖ in both sides of the following expression.

m(uₓ(t),u_{y}(t),t)=mᵢⱼₖuₓ(t)ⁱu_{y}(t)^{j}t^{k}

Further, the following expression can be achieved.

$${\sum }_{0 {<}_{\underline{\_}} τ {<}_{\underline{\_}} K} {c}_{τ} {t}^{τ} = {\sum }_{0 {<}_{\underline{\_}} τ {<}_{\underline{\_}} K} {a}_{τ} ( … , {m}_{ijk} , … ) {t}^{τ}$$

As a result, the following linear simultaneous equation can be obtained.

aτ( . . . , mᵢⱼₖ, . . . )=cτ(1≦τ≦K)

Solving this equation enables determining mᵢⱼₖ. Here, mᵢⱼₖ cannot be uniquely determined depending on a relationship between the number of equations and the number of variables. This problem is solved by how to determine a format of the plaintext polynomial as one of the public keys, and this will be explained in a section of the key generation technique in detail.

However, when there are a plurality of candidates for the identification polynomial f(uₓ(t),u_{y}(t),t), the plaintext obtained here is not necessarily a true plaintext. Thus, in all identification polynomial candidates f(uₓ(t),u_{y}(t),t), each candidate which has succeeded in an examination using the error detection code (i.e., which has not been an error because of the error detection code) in regard to the plaintext extracted by the above-explained technique is determined as a plaintext.

When there is no candidate which has succeeded this examination, processing for a failure in decryption is carried out. In such a case, although impossible in a theoretical sense, this failure may possibly occur due to reception of an incorrect encrypted text for the reason of, e.g., miscalculation on a transmission side or falsification in a transmission path.

A key generation method in this embodiment will be finally explained. The key generation method according to this embodiment is classified into an algebraic surface generation method, a plaintext polynomial format generation method, and an identification polynomial format generation method.

The algebraic surface generation method will be first explained.

An algebraic surface is generated by randomly selecting the section D and calculating a corresponding fibration.

First, the section D=(uₓ(t),u_{y}(t),t) is randomly determined so that {deg uₓ(t),deg u_{y}(t)}=d can be achieved. Here, d is a system parameter which determines difficulty of the problem of obtaining the section.

Then, a coefficient aᵢⱼ(t) except a constant term a₀₀(t) in the following fibration of the algebraic surface is randomly determined.

$$X ( x , y , t ) = {\sum }_{( i , j ) ∈ {Λ}_{X}} {a}_{ij} ( t ) {x}^{i} {y}^{j}$$

Incidentally, it is assumed that a basic format of X(x,y,t) is preset in this embodiment. Then, the constant term a₀₀(t) is determined based on the following expression.

$${a}_{00} ( t ) = - {\sum }_{( i , j ) ∈ {Λ}_{X}} {a}_{ij} ( t ) {{u}_{x} ( t )}^{i} {{u}_{y} ( t )}^{j}$$

With the above calculation, the algebraic surface including D as the section can be generated.

The plaintext polynomial format generation technique will now be explained. This generation technique is executed by determining a degree of each mᵢⱼ(t) with respect to the following basic format of the preset plaintext polynomial.

$$m ( x , y , t ) = {\sum }_{( i , j ) ∈ {Λ}_{m}} {m}_{ij} ( t ) {x}^{i} {y}^{j}$$

It is to be noted that this basic format in this example satisfies the following conditions (4) and the degree of each mᵢⱼ(t) is determined in this range. An important point in generation of the plaintext polynomial m(x,y,t) is providing the linear continuous equation constituted of the section with a unique solution. Therefore, the following processing is carried out based on the section (x,y,t)=(u(t),u_{y}(t),t) of the generated algebraic surface. First, the section is assigned to the determined basic format to derive the following expression.

$$m ( x , y , t ) = {\sum }_{( i , j , k ) ∈ {Γ}_{m}} {m}_{ijk} {{u}_{x} ( t )}^{i} {{u}_{y} ( t )}^{j} {t}^{k}$$

When this expression is organized with respect to t, the linear simultaneous equation is obtained based on coefficient comparison.

$$A ( \begin{matrix}{m}_{000} \\ {m}_{000} \\ {m}_{000} \\ ⋮ \\ {m}_{ijt} \\ ⋮\end{matrix} ) = ( \begin{matrix}{c}_{0} \\ {c}_{0} \\ {c}_{0} \\ ⋮ \\ {c}_{K}\end{matrix} )$$

Here, c₀, c₁, . . . , c_{K} are coefficients of a variable t^{τ} in the following expression generated by the decryption processing and they are sources of the finite field Fₚ.

$$m ( {u}_{x} ( t ) , {u}_{y} ( t ) , t ) = {\sum }_{τ = 0}^{K} {c}_{τ} {t}^{τ}$$

Moreover, in a case where the variable mᵢⱼₖ is represented as a Kth element in a variable vector (m₀₀₀, m₀₀₁, . . . , mᵢⱼₖ, . . . ), a matrix A is a matrix represented as coefficients of (τ,K) components in the matrix A when mᵢⱼₖ as the coefficient of t^{τ} is represented as a non-zero source in the matrix A, and it is a matrix represented as 0 with respect to (τ,K) components when mᵢⱼₖ is not represented. That is, it is assumed that the following expression can be achieved with respect to a variable vector (m₀₀₀, m₀₀₁, m₀₀₂, m₀₁₀, m₀₁₁, m₀₁₂).

$$\{ \begin{matrix}{m}_{000} + 3 {m}_{001} + 2 {m}_{010} = {c}_{0} \\ 2 {m}_{001} + {m}_{002} + {m}_{011} = {c}_{1} \\ 3 {m}_{000} + 2 {m}_{011} + {m}_{012} = {c}_{2}\end{matrix}$$

In this case, the following expression can be attained.

$$A = ( \begin{matrix}1 & 3 & 0 & 2 & 0 & 0 \\ 0 & 2 & 1 & 0 & 1 & 0 \\ 3 & 0 & 0 & 0 & 2 & 1\end{matrix} )$$

Meanwhile, a necessary sufficient condition for this linear simultaneous equation to have a unique solution irrespective of types of produced c₀,c₁, . . . , c_{K} is that the degree number of the vector (c₀,c₁, . . . , c_{K}) become equal to a rank of the matrix A based on the theory of linear algebra. On the other hand, since presence of a solution is guaranteed in this embodiment, the condition can be further alleviated to be “the degree number K+1 of the vector (c₀,c₁, . . . , c_{K}) must become equal to or above the rank of the matrix A”.

Therefore, calculating the rank of the matrix A and gradually reducing the rank of the matrix A by assigning a constant such as zero to mᵢⱼₖ corresponding to a higher degree of t when the rank is higher than the degree number K+1 of the vector enables achieving uniqueness. Here, since a plaintext cannot be embedded in the variable mᵢⱼₖ set to zero, a maximum value of k in mᵢⱼₖ which may be a non-zero value in each (i,j) is determined as a degree of mᵢⱼ(t). This determines the format of the plaintext polynomial. However, a higher-order term of any mᵢⱼ(t) must be set to a non-zero value to satisfy the conditions (4).

As to generation of a format of the identification polynomial, it is good enough to determine a basic format of the identification polynomial so that the conditions (5) can be satisfied.

$$f ( x , y , t ) = {\sum }_{( i , j ) ∈ {Λ}_{f}} {f}_{ij} ( t ) {x}^{i} {y}^{j}$$

<Variations>

Several variations in this embodiment will be finally explained. It is to be noted that r(x,y,t) will be simply written in case of a common event that r₁(x,y,t) and r₂(x,y,t) do not have to be discriminated from each other, and s(x,y,t) will be simply written in case of a common event that s₁(x,y,t) and s₂(x,y,t) do not have to be discriminated from each other. This can be likewise applied to encrypted texts F₁(x,y,t) and F₂(x,y,t).

A first variation is a variation concerning a modification of Expression (6) that generates an encrypted text in the encryption processing. Encryption/decryption can be performed even if Expression (6) is modified as follows, for example.

F(x,y,t)=m(x,y,t)−f(x,y,t)s(x,y,t)−X(x,y,t)r(x,y,t)

In this manner, the expression for encryption can be modified and decryption processing can be thereby changed without departing from the scope of the invention, and such a modification is included in the scope of the invention.

A second variation is a scheme that the identification polynomial f(x,y,t) is an irreducible polynomial in the encryption processing.

Although the restriction, i.e., the irreducible polynomial is not provided to the identification polynomial in this embodiment, if the irreducible polynomial is adopted, f(uₓ(t),u_{y}(t),t) may be possibly extracted as the irreducible polynomial by factorization from the following expression which can be calculated from two one-variable polynomials obtained by assigning the section to two encrypted texts.

f(uₓ(t),u_{y}(t),t){s₁(uₓ(t),u_{y}(t),t)−s₂(uₓ(t),u_{y}(t),t)}

Also, the number of factors is probabilistically reduced, and extraction of f(uₓ(t),u_{y}(t),t) can be facilitated.

A third variation is a scheme of embedding a plaintext m also in the identification polynomial f(x,y,t) in the encryption processing. Although the scheme of randomly generating the identification polynomial has been explained in the foregoing embodiment, a difficulty in acquisition of f(x,y,t) without a private key is also one of properties of the public key cryptography according to the present invention, and hence the scheme of embedding plaintext information likewise in the identification polynomial can be realized. Contrary, when embedding a plaintext in f(x,y,t) like this variation, there can be obtained an effect that the plaintext having a larger size can be once encrypted. However, when executing this variation together with the second variation, since f(x,y,t) as a result of embedding must be set as the irreducible polynomial, it is necessary to previously determine that random coefficients can be embedded in specific coefficients. Since great many irreducible polynomials are present, even if plaintexts are embedded in some of coefficients, the irreducible polynomials can be obtained in most cases.

A fourth variation is a scheme of generating random polynomials s(x,y,t) and r(x,y,t) in such a manner that a term f(x,y,t)s(x,y,t) and a term X(x,y,t)r(x,y,t) include the same like terms as polynomials of x and y and degrees of one-variable polynomials each including a variable t which is a coefficient in these like terms match with each other in the encryption processing. According to this variation, security is increased since the term f(x,y,t)s(x,y,t) and the term X(x,y,t)r(x,y,t) cannot be discriminated from each other in an encrypted text. Further, as to m(x,y,t) regarded as a polynomial of x and y, when it is included in the like term of X(x,y,t)r(x,y,t) (or f(x,y,t)s(x,y,t)) and its degree is lower than a degree of the corresponding like term included in X(x,y,t)r(x,y,t), m(x,y,t) cannot be discriminated from the term X(x,y,t)r(x,y,t), thus increasing security.

A fifth variation copes with a case where two or more correct plaintexts are calculated in the decryption processing. In this embodiment, h₁(t)−h₂(t) is factorized and factors are combined in such a manner that a degree precisely becomes deg f(uₓ(t),u_{y}(t),t), thereby obtaining a candidate for the identification polynomial f(uₓ(t),u_{y}(t),t). Then, a plaintext candidate M associated therewith is calculated, whether this plaintext candidate is correct is judged based on an error detection coder included in this plaintext candidate M, the processing is stopped to output the plaintext when it is determined that the candidate is correct. On the other hand, in the variation, plaintext candidates are calculated from all identification polynomial candidates, the above-explained examination is carried out, and the plaintext candidates which have been successful in the examination (i.e., having the error detection code from which an error is not detected) alone are recorded.

At this time, when there are the plurality of candidates or there is no candidate at all at the end of the processing involved in all the identification polynomial candidates, this is regarded as a failure in decryption and appropriate processing is performed. When such a configuration is adopted, it is possible to cope with an error in a case where two or more plaintexts are calculated due to a low capability of the error detection code or accidental coincidence.

A sixth variation is a scheme utilizing a plurality of sections in the decryption processing. Although only one section is used in this embodiment, utilizing a plurality of sections enables calculating a correct plaintext without using the error detection code. When the plurality of sections are utilized, the decryption processing according to this embodiment is performed in accordance with each section, and a plaintext which is a common part for a set of output plaintext candidates can be output as a correct plaintext. On the other hand, although depending on each section (which can be probabilistically substantially ignored), in the decryption processing, the following expression can be provided, and a plaintext candidate cannot be possibly obtained at all.

s₁(uₓ(t),u_{y}(t),t)−s₂(uₓ(t),u_{y}(t),t)=0

In such a case, this variation is useful. It is to be noted that this variation can be carried out with the fifth variation.

Here, to realize the sixth variation, a technique of generating an algebraic surface having a plurality of sections must be explained. A key generation technique of generating an algebraic surface having two sections D₁ and D₂ will now be described.

In this key generation, the sections D₁ and D₂ are randomly selected, and a fibration associated with these sections is performed based on calculation. However, the following ingenuity must be exercised to enable the generated algebraic surface to have the two sections at the same time. The (fibration of) algebraic surface is written as follows.

$$X ( x , y , t ) = {\sum }_{( i , j ) ∈ {Λ}_{x}} {a}_{ij} ( t ) {x}^{i} {y}^{j}$$

Here, the sections D₁ and D₂ are determined as follows.

D₁:(x,y,t)=(uₓ(t),u_{y}(t),t)

D₂:(x,y,t)=(uₓ(t),u_{y}(t),t)

They are assigned to the algebraic surface X to obtain the following expressions.

Σ_{(i,j)}aᵢⱼ(t)uₓ(t)ⁱu_{y}(t)^{j}=0

Σ_{(i,j)}aᵢⱼ(t)vₓ(t)ⁱv_{y}(t)^{j}=0

When these expressions are subjected to subtraction, a constant term a₀₀(t) which is common to both the expressions is eliminated, and Expression (9) can be obtained.

$${a}_{10} ( t ) ( {u}_{x} ( t ) - {v}_{x} ( t ) = - {\sum }_{( i , j ) \neq ( 0 , 0 ) , ( 1 , 0 )} {a}_{ij} ( t ) ( {{u}_{x} ( t )}^{i} {{u}_{y} ( t )}^{j} - {{v}_{x} ( t )}^{i} {{v}_{y} ( t )}^{j} ) \qquad ( 9 )$$

Here, a₁₀(t) serving as a polynomial is generated from the following relational expression.

uₓ(t)ⁱu_{y}(t)^{j}−vₓ(t)ⁱv_{y}(t)^{j}=(uₓ(t)ⁱ−vₓ(t)ⁱ)u_{y}(t)^{j}+vₓ(t)ⁱ(u_{y}(t)^{j}−v_{y}(t)^{j}) (10)

To realize this, setting the following expression can suffice.

uₓ(t)−vₓ(t)|u_{y}(t)−v_{y}(t)

(It is to be noted that the notation A|B means that the B is dividable by A, i.e., B is a multiple (a multiple expression) of A). This is apparent from Expression (10) and the following expressions.

(uₓ(t)−vₓ(t))|(uₓ(t)ⁱ−vₓ(t)ⁱ)

(u_{y}(t)−v_{y}(t))|(u_{y}(t)^{j}−v_{y}(t)^{j})

Utilizing the above-explained settings enables performing key generation based on the following algorithm. First, two polynomials that become λₓ(t)|λ_{y}(t) are randomly selected.

Specifically, to obtain such as set of polynomials λₓ(t) and λ_{y}(t), when d is determined as a maximum degree of a section, it is good enough to, e.g., randomly give λₓ(t) which is a dth or lower degree and calculate λ_{y}(t)=c(t)λₓ(t) based on a random polynomial c(t) whose degree is d−deg λₓ(t) or below.

Here, the following expressions are determined

λₓ(t)=uₓ(t)−vₓ(t),λ_{y}(t)=u_{y}(t)−v_{y}(t)

Subsequently, a polynomial vₓ(t) is randomly selected, and uₓ(t) is calculated based on the following expression.

uₓ(t)=λₓ(t)+vₓ(t)

Since degrees of λₓ(t) and vₓ(t) are equal to or below d, a degree of uₓ(t) also becomes d or below.

Likewise, a polynomial v_{y}(t) is randomly selected, and u_{y}(t) is calculated based on the following expression.

u_{y}(t)=λ_{y}(t)+v_{y}(t)

Likewise, since degrees of λ_{y}(t) and v_{y}(t) are equal to or below d, a degree of u_{y}(t) also becomes d or below.

Then, a coefficient aᵢⱼ(t)((i,j)≠(0,0),(1,0)) other than a₀₀(t) and a₁₀(t) x is randomly generated, and uₓ(t), vₓ(t), u_{y}(t), and v_{y}(t) calculated as explained above are utilized to calculate a₁₀(t) based on expression (9). Further, the polynomial a₀₀(t) can be obtained by calculating the following expression.

$${a}_{00} ( t ) = - {\sum }_{( i , j ) \neq ( 0 , 0 )} {a}_{ij} ( t ) ( {{u}_{x} ( t )}^{i} {{u}_{y} ( t )}^{j} - {{v}_{x} ( t )}^{i} {{v}_{y} ( t )}^{j} ) \qquad ( 11 )$$

To obtain an algebraic surface having three or more sections, the following section is randomly determined.

Dₙ:(x,y,t)=(uₓ_{ₙ}(t),u_{y}_{ₙ}(t),t)

Then, the following factors are generated from these polynomials.

(x−uₓ_{ₙ}(t)),(y−u_{y}_{ₙ}(t))

Subsequently, one equation is formed in such a manner that factors associated with the same n are multiplied on both sides. For example, the following expression is an equation satisfying the conditions, and spreading this equation enables obtaining an algebraic surface as a public key.

(x−uₓ_{₁}(t))(x−uₓ_{₂}(t)) . . . (x−uₓ_{ₙ}(t))=(y−u_{y}_{₁}(t))(y−u_{y}_{₂}(t)) . . . (y−u_{y}_{ₙ}(t)) (12)

On the other hand, in Expression (12), since factors of x are provided on a right-hand side whilst factors of y are provided on a left-hand side, obtaining sections based on factorization is easy. Thus, for example, it is desirable to generate an algebraic surface as public key cryptography by randomly providing factors of x and factors of y on both sides like the following expression.

(x−uₓ₁(t))(y−u_{y2}(t)) . . . (x−uₓₙ(t))=(y−u_{y1}(t))(x−uₓ₂(t)) . . . (y−u_{yn}(t))

Generating the public key and the private key in this manner enables producing an algebraic surface generally having n or more sections.

<Review of Safety>

Safety of public key cryptography according to the present invention constituted in this embodiment will now be considered hereinafter.

[1] Round-Robin Attack

Respective elements m(x,y,t), f(x,y,t), s(x,y,t), and r(x,y,t) constituting an encrypted text F(x,y,t) are provided as follows with mᵢⱼₖ, fᵢⱼₖ, sᵢⱼₖ, and rᵢⱼₖ being determined as variables.

$$m ( x , y , t ) = {\sum }_{( i , j , k ) ∈ {Γ}_{m}} {m}_{ijk} {x}^{i} {y}^{j} {t}^{k}$$

$$f ( x , y , t ) = {\sum }_{( i , j , k ) ∈ {Γ}_{f}} {f}_{ijk} {x}^{i} {x}^{j} {t}^{k}$$

$$s ( x , y , t ) = {\sum }_{( i , j , k ) ∈ {Γ}_{s}} {s}_{ijk} {x}^{i} {y}^{j} {t}^{k}$$

$$r ( x , y , t ) = {\sum }_{( i , j , k ) ∈ {Γ}_{r}} {r}_{ijk} {x}^{i} {y}^{j} {t}^{k}$$

There can be considered an attack which compares these elements with the encrypted text F(x,y,t) to generate a multi-degree multi-variable simultaneous equation system and solves this equation system. However, in this case, r(x,y,t) is regarded as a polynomial of x and y, sufficiently many terms are included, and a degree of a polynomial serving as a coefficient of each term when regarded as a polynomial of x and y is sufficiently increased. As a result, the number of variables can be increased so that a solution cannot be readily obtained. For example, at present, it is very difficult to solve a multi-degree multi-variable simultaneous equation having approximately 100 variables by a current throughput of a computer and a processing technique. Thus, this attack can be avoided by increasing terms or the degree of the coefficient in such a manner that the number of variables exceeds 100.

[2] Reduction Attack

In the public key cryptography according to the present invention, the algebraic surface X(x,y,t) alone is disclosed. Thus, whether m(x,y,t)+f(x,y,t)s(x,y,t) can be obtained as a residue when an encrypted text F(x,y,t) is divided by X(x,y,t) must be examined. However, in case of division of three-variable polynomials, a residue cannot be uniquely obtained. That is because a theorem of division cannot be attained in case of a polynomial having two or more variables as explained in a referenced document (D. Cox et. al., “An Introduction to Commutative Algebraic Geometry and Commutative Algebra (Volume 1)”, Springer Verlag Tokyo, (2000), p. 94, Example 4).

[3] Assignment Attack

[3-1] Attack of Assigning Algebraic Curve on Algebraic Surface

Algebraic curves (including sections) can be represented like Expression (13) with w being used as a parameter.

(x,y,t)=(uₓ(ω),u_{y}(ω),uₜ(ω)) (13)

If an algebraic curve included in an algebraic surface X(x,y,t) can be found from these curves, this curve can be assigned in place of the section, and the same technique as decryption using the section can be used to perform decryption. Here, finding such an algebraic curve means being equal to finding the given section or a difficulty in calculation beyond this finding. Such curves are classified while paying attention to deg uₜ(ω).

When deg uₜ(ω)≧2

In this case, a general factor is provided, and a threat is not posed because of a difficulty in a factor acquisition problem.

When deg uₜ(ω)=1

When this is obtained, a section is acquired by linear transformation, and hence obtaining such an algebraic curve becomes also difficult on the assumption that a section acquisition problem is difficult.

When deg uₜ(ω)=0

This is called a singular fiber, and it is present in almost all algebraic surfaces. However, this corresponds to a case where a general factor acquisition problem is special, and an efficient solving method is not known.

[3-2] Attack of Assigning Algebraic Curve other than Algebraic Surface

An algebraic curve outside an algebraic surface can be likewise written as Expression (13), and it is X(uₓ(ω),u_{y}(ω),uₜ(ω))≠0. Therefore, the following expression can be obtained.

F(uₓ(ω),u_{y}(ω),uₜ(ω))=m(uₓ(ω),u_{y}(ω),uₜ(ω))+f(uₓ(ω),u_{y}(ω),uₜ(ω))s(uₓ(ω),u_{y}(ω),uₜ(ω))+X(uₓ(ω),u_{y}(ω),uₜ(ω))r(uₓ(ω),u_{y}(ω),uₜ(ω))

However, since the expression known here is X(uₓ(ω),u_{y}(ω),uₜ(ω)), there can be considered an attack that reduces F(uₓ(ω),u_{y}(ω),uₜ(ω)) with X(uₓ(ω),u_{y}(ω),uₜ(ω)). This is possible since the number of variable is one, but obtaining an accurate residue is difficult since a degree of m(uₓ(ω),u_{y}(ω),uₜ(ω))+f(uₓ(ω),u_{y}(ω),uₜ(ω))s(uₓ(ω), u_{y}(ω),uₜ(ω)) is higher than a degree of X(uₓ(ω),u_{y}(ω),uₜ(ω)) because of the conditions (4) and (5).

[3-3] Attack of Assigning Assigns Rational Point on Algebraic Surface

There is an attack that assigns a rational point (a point where X(x,y,t)=0 is achieved) on an algebraic surface X(x,y,t). That is, mᵢⱼₖ, fᵢⱼₖ, and sᵢⱼₖ are determined as unknown numbers, and the following expressions are provided.

$$m ( x , y , t ) = {\sum }_{( i , j , k ) ∈ {Γ}_{m}} {m}_{ijk} {x}^{i} {y}^{j} {t}^{k}$$

$$f ( x , y , t ) = {\sum }_{( i , j , k ) ∈ {Γ}_{f}} {f}_{ijk} {x}^{i} {x}^{j} {t}^{k}$$

$$s ( x , y , t ) = {\sum }_{( i , j , k ) ∈ {Γ}_{s}} {s}_{ijk} {x}^{i} {y}^{j} {t}^{k}$$

Since it is known that a large quantity of K rational points (xᵢ,yᵢ,tᵢ) on an algebraic surface X(x,y,t)=0 (as a public key) can be relatively easily obtained (no matter what the algebraic surface is), a large quantity of the following relational expressions can be obtained by assigning these rational points to an encrypted text F(x,y,t).

F(xᵢ,yᵢ,tᵢ)=m(xᵢ,yᵢ,tᵢ)+f(xᵢ,yᵢ,tᵢ)s(xᵢ,yᵢ,tᵢ)

Here, K means Fₚ and its extension field.

When these expressions are simultaneously achieved, m(x,y,t) may be possibly solved. However, f(x,y,t) and s(x,y,t) are random polynomials, and especially f(x,y,t)s(x,y,t) includes all like terms comprised in X(x,y,t)r(x,y,t) and degrees of coefficients in respective terms are equal to each other. Therefore, when the degree of each coefficient in r(x,y,t) is sufficiently increased, the degree of each coefficient of s(x,y,t) is also necessarily increased so that the simultaneous equations cannot be solved, and calculation is actually impossible. Therefore, such an attack is not a threat for the public key cryptography according to the present invention.

On the other hand, when a factor of s₁(x,y,t) is deleted from the encrypted text, the linear simultaneous equation becomes as follows.

F₁(xᵢ,yᵢ,tᵢ)=m(xᵢ,yᵢ,tᵢ)+f(xᵢ,yᵢ,tᵢ)

When the linear simultaneous equation is solved, a coefficient can be relatively easily obtained. The factor s(x,y,t) is present for this reason.

Moreover, when an element of an identification polynomial f(x,y,t) is deleted from the encrypted text, the following expression can be provided by this attack.

F₁(xᵢ,yᵢ,tᵢ)=m(xᵢ,yᵢ,tᵢ)+s₁(xᵢ,yᵢ,tᵢ)

Additionally, a plaintext polynomial m(x,y,t) can be relatively easily obtained. An element including the identification polynomial f(x,y,t) is present for this reason.

As explained above, the public key cryptography according to the present invention is resistant to the above-explained attacks. That is (contrary), each constituent element is set so that the public key cryptography according to the present invention becomes resistant.

### Specific Structure of One Embodiment

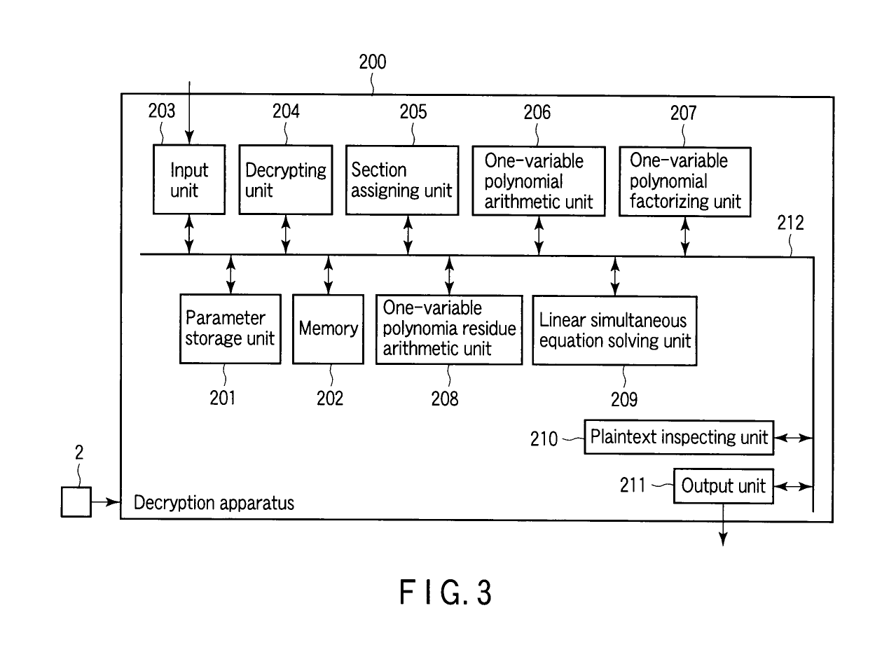

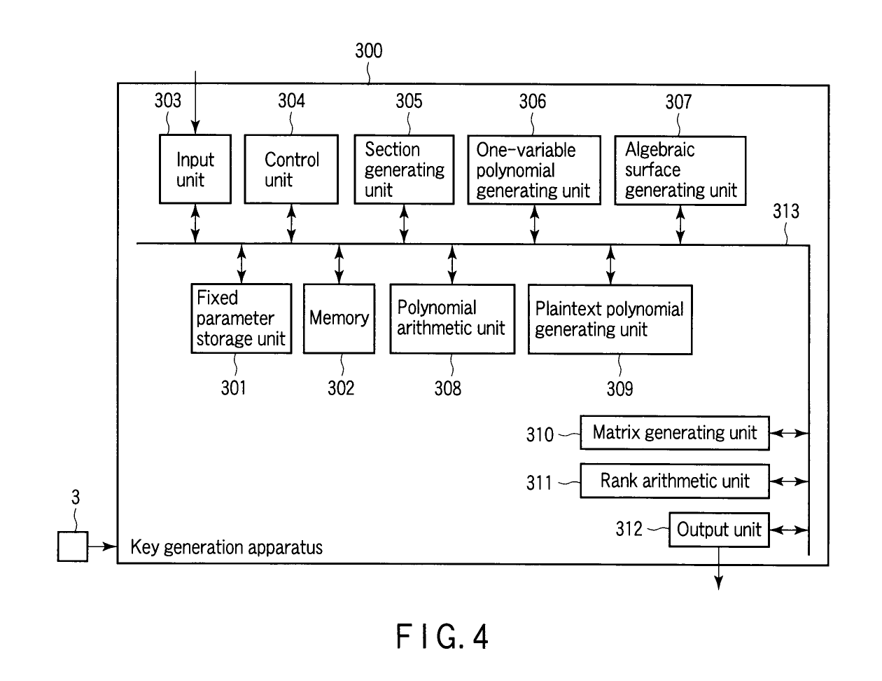

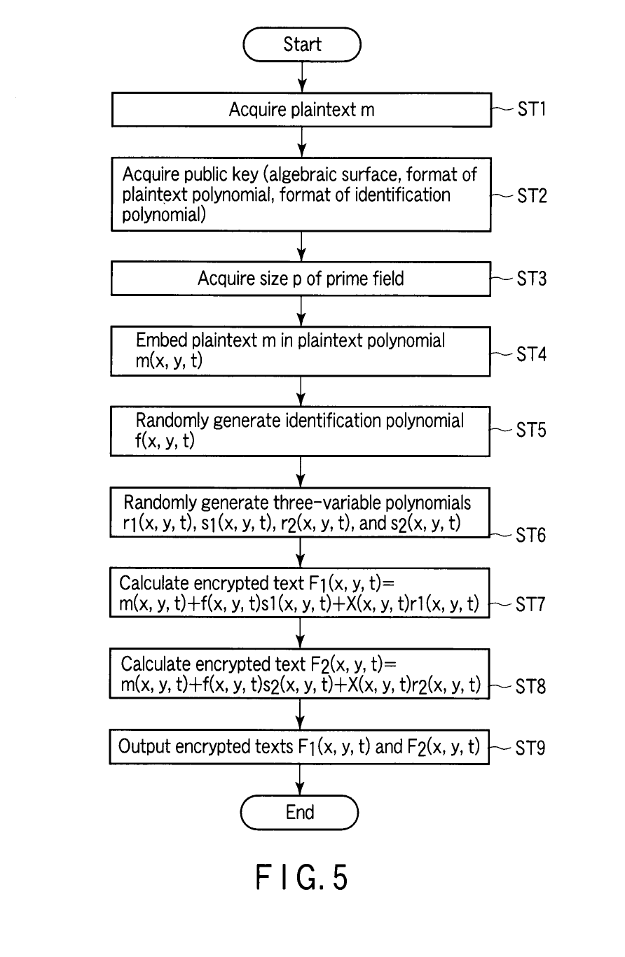

An embodiment according to the present invention will now be specifically explained. FIG. 2 is an overall block diagram of an encryption apparatus according to a first embodiment of the present invention, and FIG. 3 is an overall block diagram of a decryption apparatus according to the first embodiment. FIG. 4 is an overall block diagram of a key generation according to the first embodiment.

It is to be noted that each of an encryption apparatus 100, a decryption apparatus 200, and a key generation apparatus 300 explained below can be realized by using a hardware structure or a combined structure of a hardware resource and software in accordance with each apparatus 100, 200, or 300. As software in the combined structure, a program that is installed in a computer in a corresponding apparatus from a network or a storage medium 1, 2, or 3 in advance to realize a function of the corresponding apparatus is used.

Here, as shown in FIG. 2, in the encryption apparatus 100, a system parameter storage unit 101, a memory 102, an input unit 103, a plaintext embedding unit 104, an encrypting unit 105, an identification polynomial generating unit 106, a polynomial generating unit 107, a random value generating unit 108, a polynomial arithmetic unit 109, and an output unit 110 are connected with each other through a bus 111.

The parameter storage unit 101 is a memory having information that can be read from the encrypting unit 105, and stores a characteristic p of a prime field as a system parameter.

The memory 102 is a storage device into or from which information can be read/written through the respective units 103 to 109.

The input unit 103 has a function of transmitting a format Λₘ, deg mᵢⱼ(t) of a plaintext polynomial and a plaintext m input from the outside to the plaintext embedding unit 104 and a function of transmitting public keys X(x,y,t), Λₘ, Λ_{f}, deg mᵢⱼ(t), and deg fᵢⱼ(t) input from the outside to the encrypting unit 105.

The plaintext embedding unit 104 has a function of embedding the plaintext m in a coefficient of the plaintext polynomial m(x,y,t) based on the format of the plaintext polynomial and the plaintext m received from the input unit 103 and a function of transmitting the obtained plaintext polynomial m(x,y,t) to the encrypting unit 105.

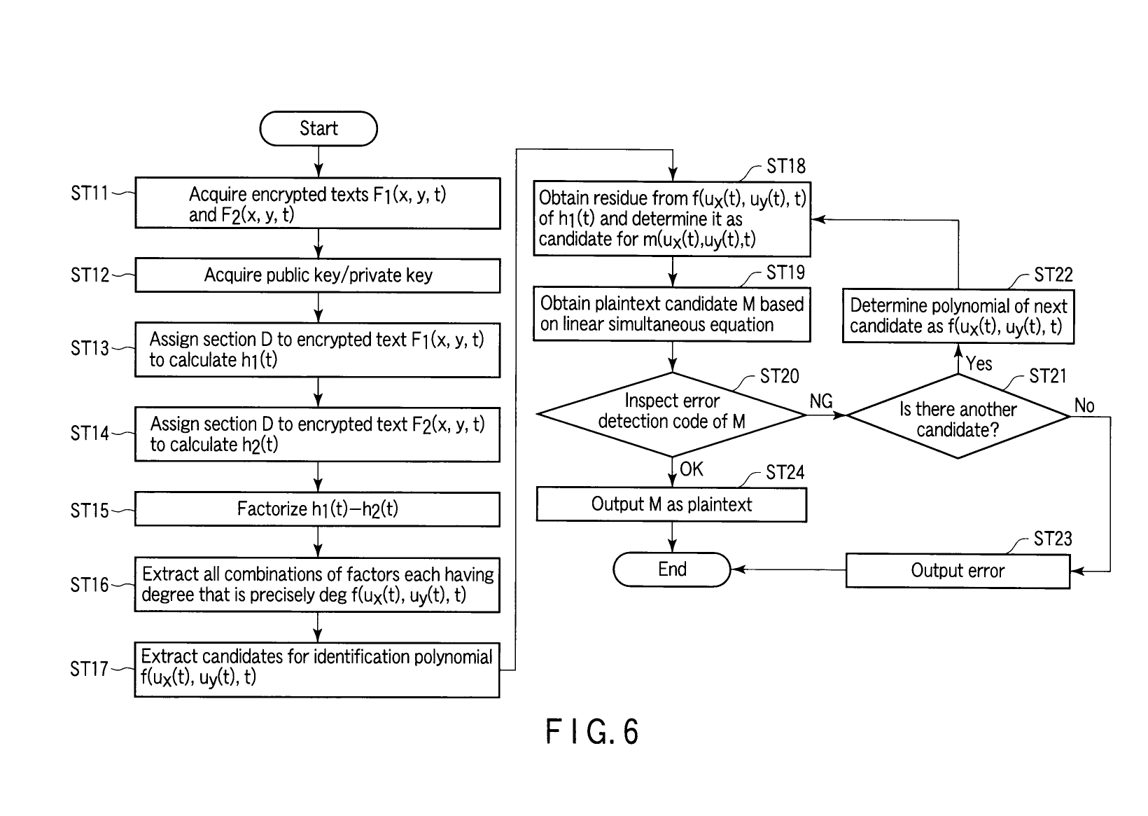

The encrypting unit 105 has a function of controlling the respective units 102 and 106 to 109 based on the public keys accepted from the input unit 103 and the parameter p in the parameter storage unit 101 to execute operations denoted by ST5 to ST9 in FIG. 5.

The identification polynomial generating unit 106 has a function of randomly generating an identification polynomial f(x,y,t) based on the format of the identification polynomial f(x,y,t) accepted from the encrypting unit 105 and the parameter p and a function of transmitting the obtained identification polynomial f(x,y,t) to the encrypting unit 105.

The polynomial generating unit 107 has a function of repeatedly requesting the random value generating unit 108 to output random values upon receiving an instruction of generating polynomials r₁(x,y,t), s₁(x,y,t), r₂(x,y,t), and s₂(x,y,t) from the encrypting unit 105, and utilizing the obtained random values to generate the four polynomials r₁(x,y,t), s₁(x,y,t), r₂(x,y,t), and s₂(x,y,t), and a function of transmitting the generated polynomials r₁(x,y,t), s₁(x,y,t), r₂(x,y,t), and s₂(x,y,t) to the encrypting unit 105.

The random value generating unit 108 has a function of generating a random value in response to the output request received from the polynomial generating unit 107 and transmitting this random value to the polynomial generating unit 107.

The polynomial arithmetic unit 109 has a function of executing a polynomial arithmetic operation based on the polynomials received from the encrypting unit 105 and an arithmetic operation instruction thereof and transmitting an arithmetic operation result to the encrypting unit 105.

The output unit 110 has a function of outputting encrypted texts F₁(x,y,t) and F₂(x,y,t) accepted from the encrypting unit 105.

In the decryption apparatus 200, as shown in FIG. 3, a parameter storage unit 201, a memory 202, an input unit 203, a decrypting unit 204, a section assigning unit 205, a one-variable polynomial arithmetic unit 206, a one-variable polynomial factorizing unit 207, a one-variable polynomial residue arithmetic unit 208, a linear simultaneous equation solving unit 209, a plaintext inspecting unit 210, and an output unit 211 are connected with each other through a bus 212.

The parameter storage unit 201 is a memory in which information can be read by the decrypting unit 204, and stores a characteristic p of a prime field as a system parameter.

The memory 202 is a storage apparatus from/into which information can be written through the respective units 203 to 211.

The input unit 203 has a function of transmitting encrypted texts F₁(x,y,t) and F₂(x,y,t), a public key x(x,y,t), and a section D input from the outside to the decrypting unit 204.

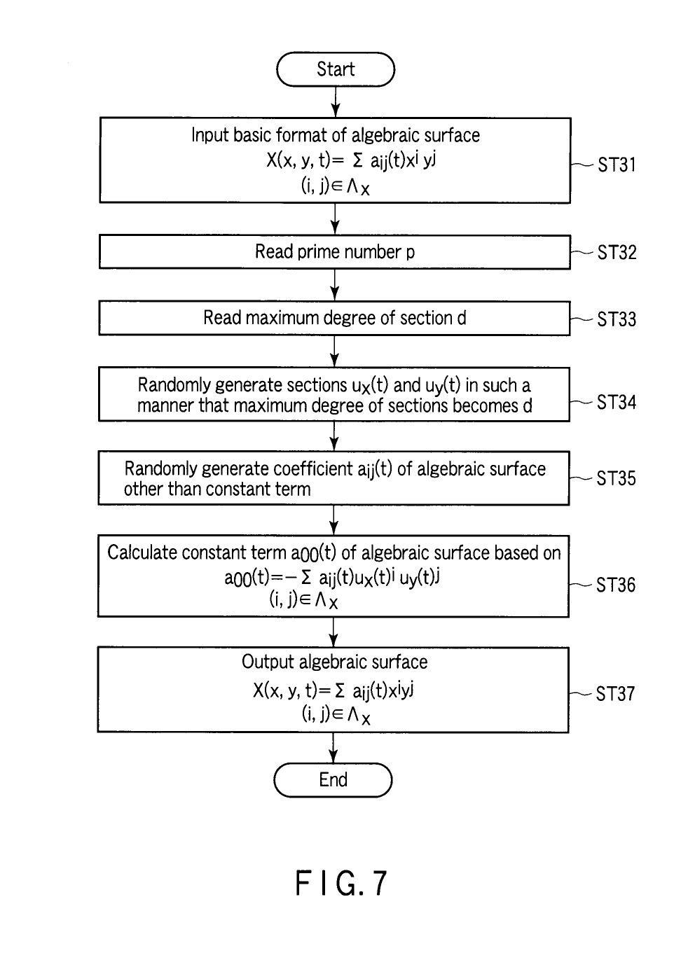

The decrypting unit 204 has a function of controlling the respective units 202 and 205 to 211 to execute operations denoted by ST12 to ST24 in FIG. 6 based on the encrypted texts F₁(x,y,t) and F₂(x,y,t), the public key x(x,y,t), and the section D accepted from the input unit 204.

The section assigning unit 205 has a function of assigning the section D to the encrypted text F₁(x,y,t) to obtain a one-variable polynomial h₁(t) upon receiving the encrypted texts F₁(x,y,t) and F₂(x,y,t), and the section D from the decrypting unit 204, a function of assigning the section D to the encrypted text F₂(x,y,t) to obtain a one-variable polynomial h₂(t), and a function of transmitting the obtained h₁(t) and h₂(t) to the decrypting unit 204.

The one-variable polynomial arithmetic unit 206 has a function of executing adding/subtracting/multiplying/dividing operations with respect to the one-variable polynomial received from the section assigning unit 205 or the decrypting unit 204, and a function of transmitting an arithmetic operation result to the section assigning unit 205 or the decrypting unit 204.

The one-variable polynomial factorizing unit 207 has a function of factorizing a one-variable polynomial, e.g., a subtraction result {h₁(t)−h₂(t)} received from the decrypting unit 204, and a function of transmitting a factorization result to the decrypting unit 204 as an alignment in which factors are sequenced.

The one-variable polynomial residue arithmetic unit 208 has a function of executing a residue arithmetic operation with respect to one-variable polynomials as a dividend polynomial and a divisor polynomial received from the decrypting unit 204, and a function of transmitting a residue as an arithmetic operation result to the decrypting unit 204.

The linear simultaneous equation solving unit 209 has a function of solving a linear simultaneous equation received from the decrypting unit 204 based on a matrix operation, and a function of transmitting an obtained solution to the decrypting unit 204.

The plaintext inspecting unit 210 has a function of inspecting an error detection code in a plaintext candidate M received from the decrypting unit 204, and a function of transmitting an inspection result to the decrypting unit 204.

The output unit 211 has a function of outputting a plaintext m received from the decrypting unit 204.

In the key generation apparatus 300, as shown in FIG. 4, a fixed parameter storage unit 301, a memory 302, an input unit 303, a control unit 304, a section generating unit 305, a one-variable polynomial generating unit 306, an algebraic surface generating unit 307, a polynomial arithmetic unit 308, a plaintext polynomial generating unit 309, a matrix generating unit 310, a rank arithmetic unit 311, and an output unit 312 are connected with each other through a bus 313.

The fixed parameter storage unit 301 is a memory from which information can be read by the control unit 304, and stores a prime number p and a maximum degree d of a section as fixed parameters.

The memory 302 is a storage device from/into which information can be read/written through the respective units 303 to 312.

The input unit 303 has a function of temporarily storing a basic format of an algebraic surface X input from the outside or a basic format of a plaintext polynomial in the memory 302 and transmitting the basic format of the algebraic surface X or the basic formation of the plaintext polynomial in the memory 302 to the control unit 304.

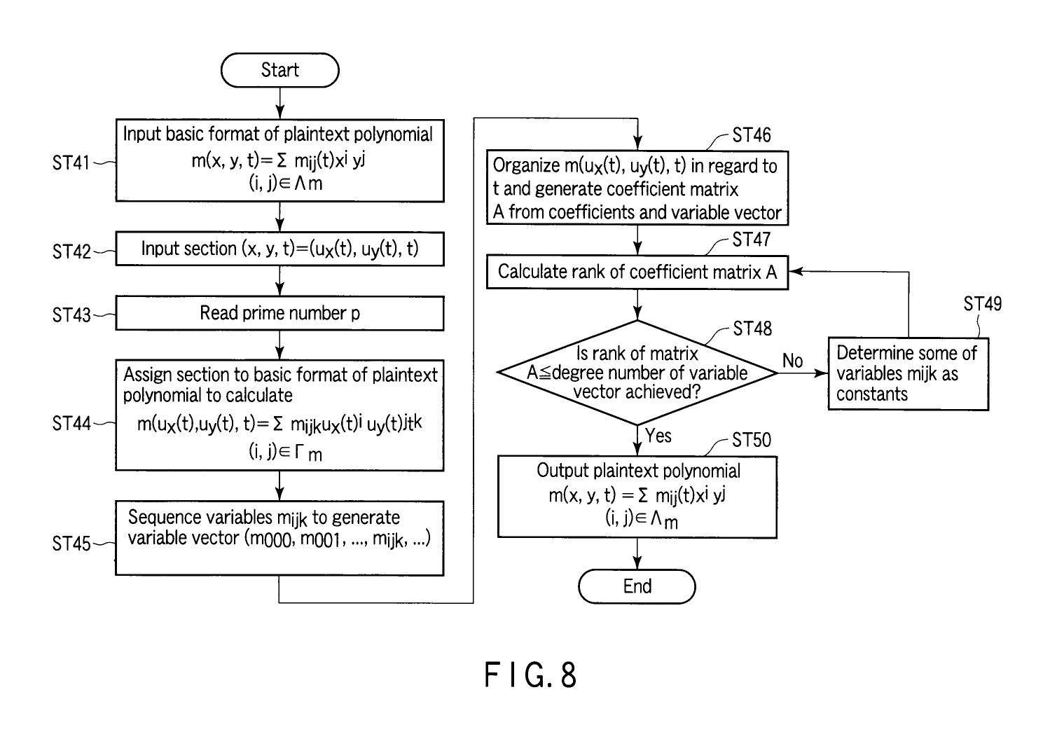

The control unit 304 has a function of controlling the respective units 302 and 305 to 312 to execute operations denoted by ST34 to ST37 depicted in FIG. 7 based on the basic format of the algebraic surface X received from the input unit 303 and fixed parameters p and d in the fixed parameter storage unit 301, and a function of controlling the respective units 302 and 305 to 312 to execute operations denoted by ST44 to ST50 in FIG. 8 based on the basic format of the plaintext polynomial and a section received from the input unit 303 and the fixed parameter p in the fixed parameter storage unit 301.

The section generating unit 305 has a function of generating a section D:(x,y,t)=(uₓ(t),u_{y}(t),t) from two one-variable polynomials uₓ(t) and u_{y}(t) generated by the one-variable polynomial generating unit 306 based on the fixed parameters p and d received from the control unit 304 and transmitting the generated section to the control unit 304.

The one-variable polynomial generating unit 306 has a function of generating one-variable polynomials uₓ(t) and u_{y}(t) having a degree d on a prime field Fₚ based on the fixed parameters p and d received from the section generating unit 305 and transmitting these one-variable polynomials uₓ(t) and u_{y}(t) to the section generating unit 305.

The algebraic surface generating unit 307 has a function of generating a term other than a constant term by randomly producing a coefficient of the term other than the constant term based on the section D, the basic format of the algebraic surface, and the prime number p received from the control unit 304, a function of using the polynomial arithmetic unit 308 to generate a constant term having a negative sign by assigning the section D to the term other than the constant term and further generating an algebraic surface X as a fibration X(x,y,t) constituted of the term other than the constant term and the constant term, and a function of transmitting this algebraic surface X to the control unit 304.

The polynomial arithmetic unit 308 is controlled by the algebraic surface generating unit 307 and has a function of executing a polynomial arithmetic operation and transmitting an arithmetic operation result to the algebraic surface generating unit 307.

The plaintext polynomial generating unit 309 has a function of assigning a section with a coefficient mᵢⱼₖ in a plaintext polynomial being used as a variable based on the basic format of the plaintext polynomial and data of the prime number p received from the control unit 304 and the section in the memory 302, a function of transmitting a polynomial having a variable vector (m₀₀₀, m₀₀₁, . . . , mᵢⱼₖ, . . . ) obtained by sequencing mᵢⱼₖ acquired as a result of assignment and t as variables to the matrix generating unit 310, a function of transmitting to the rank arithmetic unit 311 an instruction for calculating a rank of a coefficient matrix A accepted from the matrix generating unit 310, a function of comparing the rank received from the rank arithmetic unit 311 with a degree number of the variable vector to judge whether the rank is equal to or below the degree number of the variable vector, a function of using some of the variables mᵢⱼₖ as constants and again issuing an instruction to the rank arithmetic unit 311 if the rank is not equal to or below the degree number as a result of the judgment, and a function of transmitting a format of a plaintext polynomial to the control unit 304 if the rank is equal to or below the degree number of the vector.

The matrix generating unit 310 has a function of organizing a plaintext polynomial m(uₓ(t),u_{y}(t),t) in relation to a variable t upon receiving the variable vector (m₀₀₀, m₀₀₁, . . . , mᵢⱼₖ, . . . ) and the plaintext polynomial m(uₓ(t),u_{y}(t),t) from the plaintext polynomial generating unit 309 and generating a coefficient matrix A representing coefficients including the variables mᵢⱼₖ by using a variable vector, and a function of transmitting the coefficient matrix A to the plaintext polynomial generating unit 309.

The rank arithmetic unit 311 has a function of calculating a rank of the coefficient matrix A and transmitting the calculated rank to the plaintext polynomial generating unit 309 based on an instruction of calculating the rank of the coefficient matrix A upon receiving this instruction from the plaintext polynomial generating unit 309.

The output unit 312 has a function of outputting a format of the plaintext polynomial m(x,y,t) received from the plaintext polynomial generating unit 309.

Operations of the encryption apparatus, the decryption apparatus, and the key generation apparatus having the above-described structures will now be explained with reference to flowcharts in FIGS. 5 to 8.

(Encryption Processing)

In the encryption apparatus 100, as shown in FIG. 5, when a plaintext m is obtained from the input unit 103 (ST1) and a fibration X(x,y,t) of an algebraic surface, a format of a plaintext polynomial m(x,y,t), and a format of an identification polynomial f(x,y,t) as public keys are acquired from the input unit 103 (ST2), processing is started. Here, these formats are constituted of sets Λₘ and Λ_{f} which can be regarded as being equal to a set of non-zero terms and degrees deg mᵢⱼ(t) and deg fᵢⱼ(t) of coefficients of respective terms. Further, a characteristic p of a prime field as a system parameter is acquired from the parameter storage unit 101 (ST3) and transmitted to the plaintext embedding unit 104.

The plaintext embedding unit 104 divides the plaintext m separately received from the input unit 103 into blocks, e.g., m=m₀₀∥m₁₀∥ . . . ∥mᵢⱼ based on the format of the plaintext polynomial received from the input unit 103. Here, assuming that L=deg mᵢⱼ(t), the following expression can be achieved.

|mᵢⱼ|≦(|p|−1)(L+1)

It is assumed that a coefficient mᵢⱼₖ of t^{k} of mᵢⱼ(t) is obtained by dividing mᵢⱼ every |p|−1 bits. That is, the following expression can be attached.

mᵢⱼ=mᵢⱼ₀∥mᵢⱼ₁∥ . . . ∥m_{ijL}

Here, |p| represents a bit length of p. In this manner, the plaintext m is embedded in the coefficient of the plaintext polynomial m(x,y,t) (ST4).

The plaintext embedding unit 104 transmits the plaintext polynomial m(x,y,t) to the encrypting unit 105. On the other hand, the input unit 103 transmits the public keys to the encrypting unit 105. The parameter storage unit 101 transmits the parameter p to the encrypting unit 105.

Upon receiving the plaintext polynomial m(x,y,t), the parameter p, and the public keys, the encrypting unit 105 writes them in the memory 102. Then, the encrypting unit 105 transmits a format of the identification polynomial f(x,y,t) and the parameter p in the memory 102 to the identification polynomial generating unit 106.

The identification polynomial generating unit 106 randomly generates the identification polynomial f(x,y,t) based on the format of the identification polynomial f(x,y,t) and the parameter p (ST5), and transmits the obtained identification polynomial f(x,y,t) to the encrypting unit 105.

The encrypting unit 105 stores this identification polynomial f(x,y,t) in the memory 102, and then transmits an instruction for generation of polynomials r₁(x,y,t), s₁(x,y,t), r₂(x,y,t), and s₂(x,y,t) to the polynomial generating unit 107.

The polynomial generating unit 107 repeatedly requests the random value generating unit 108 to output random values, and utilizes random values as outputs from this unit to generate the four polynomials r₁(x,y,t), s₁(x,y,t), r₂(x,y,t), and s₂(x,y,t) (ST6). The generated polynomials r₁(x,y,t), s₁(x,y,t), r₂(x,y,t), and s₂(x,y,t) are transmitted to the encrypting unit 105 from the polynomial generating unit 107.

The encrypting unit 105 stores the received polynomials r₁(x,y,t), s₁(x,y,t), r₂(x,y,t), and s₂(x,y,t) in the memory 102, and then calculates a first encrypted text F₁(x,y,t) based on the following expression while sequentially transmitting the polynomials and an arithmetic operation instruction to the polynomial arithmetic unit 109 (ST7).

F₁(x,y,t)=m(x,y,t)+f(x,y,t)s₁(x,y,t)+X(x,y,t)r₁(x,y,t)

The calculated first encrypted text F₁(x,y,t) is stored in the memory 102 by the encrypting unit 105.

Likewise, the encrypting unit 105 calculates a second encrypted text F2(x,y,t) based on the following expression by using the polynomial arithmetic unit 109 (ST8), and stores the obtained second encrypted text F₂(x,y,t) in the memory 102.

F₂(x,y,t)=m(x,y,t)+f(x,y,t)s₂(x,y,t)+X(x,y,t)r₂(x,y,t)

Then, the encrypting unit 105 transmits the encrypted texts F₁(x,y,t) and F₂(x,y,t) in the memory 102 to the output unit 110. The output unit 110 (deforms the encrypted texts F₁(x,y,t) and F₂(x,y,t) in accordance with a predetermined format as required and) outputs the encrypted texts F₁(x,y,t) and F₂(x,y,t) (ST9).

Then, the encryption apparatus 100 terminates the encryption processing.

(Decryption Processing)

As shown in FIG. 6, the decryption apparatus 200 acquires encrypted texts F₁(x,y,t) and F₂(x,y,t) from the input unit 203 (ST11), acquires a public key X(x,y,t) and a private key from the input section 203 (ST12), and acquire p from the parameter storage unit 201 to start processing. Here, the private key is a section D. The acquired encrypted texts and key information are transmitted to the decrypting unit 204. The decrypting unit 204 stores the encrypted texts, the key information, and others in the memory 202.

The decrypting unit 204 transmits the encrypted texts F₁(x,y,t) and F₂(x,y,t) and the section D in the memory 202 to the section assigning unit 205.

The section assigning unit 205 assigns the section D to the encrypted text F₁(x,y,t), and utilizes the one-variable polynomial arithmetic unit 206 as required to obtain h₁(t) (ST13). Here, the one-variable polynomial arithmetic unit 206 performs adding/subtracting/multiplying/dividing operations with respect to a one-variable polynomial. The obtained h₁(t) is transmitted to the decrypting unit 204 from the section assigning unit 205.

Likewise, the section assigning unit 205 assigns the section D to the encrypted text F₂(x,y,t) to obtain h₂(t) (ST14). The obtained h₂(t) is transmitted to the decrypting unit 204 from the section assigning unit 205.

The decrypting unit 204 transmits h₁(t) and h₂(t) to the one-variable polynomial arithmetic unit 206 to be subtracted. The one-variable polynomial arithmetic unit 206 transmits a subtraction result {h₁(t)−h₂(t)} to the decrypting unit 204.

The decrypting unit 204 transmits the subtraction result {h₁(t)−h₂(t)} to the one-variable polynomial factorizing unit 207 to be factorized (ST15). The one-variable polynomial factoring unit 207 transmits a result of factorization to the decrypting unit 204 as an alignment in which factors are sequenced.

The decrypting unit 204 extracts all combinations having a degree that is precisely deg f(uₓ(t),u_{y}(t),t) as identification polynomial candidates from combinations of these factors (ST16). Specifically, the decrypting unit 204 can use a technique of sequentially obtaining all combinations from factors sequenced as the alignment in ascending order and extracting combinations having the degree that is precisely deg f(uₓ(t),u_{y}(t),t) alone from the obtained combinations. However, in case of executing this technique, if the number of factor is l, there are 2^{l} combinations. Thus, in addition to this technique, there is adopted a method of preventing combinations whose degree exceeds deg f(uₓ(t),u_{y}(t),t) from being further combined with factors, thereby extracting combinations of factors in a shorter processing time.

Then, the decrypting unit 204 sequentially extracts candidates for the identification polynomial f(uₓ(t),u_{y}(t),t) (ST17), and sequentially transmits the extracted candidates together with h₁(t) to the one-variable polynomial residue arithmetic unit 208.

The one-variable polynomial residue arithmetic unit 208 obtains a residue obtained by dividing h₁(t) by each candidate of the identification polynomial f(uₓ(t),u_{y}(t),t) (ST18) and transmits each obtained residue to the decrypting unit 204 as represented by the following expression.

m(uₓ(t),u_{y}(t),t)≡h₁(t)(mod f(uₓ(t),u_{y}(t),t))

Here, since degm(uₓ(t),u_{y}(t),t)<deg f(uₓ(t),u_{y}(t),t) is achieved because of the conditions (5), it can be understood that correct m(uₓ(t),u_{y}(t),t) can be obtained on the assumption that correct f(uₓ(t),u_{y}(t),t) is acquired.

Subsequently, the decrypting unit 204 determines a coefficient mᵢⱼₖ in the following plaintext polynomial m(x,y,t) as a variable.

$${\sum }_{( i , j ) ∈ {Λ}_{m}} {m}_{ij} ( t ) {x}^{i} {y}^{j}$$

Further, the decrypting unit 204 generates a linear simultaneous equation having mᵢⱼₖ as a variable by comparing coefficients of m(uₓ(t),u_{y}(t),t) acquired at step ST18 and of t^{k} in mᵢⱼₖuₓ(t)ⁱu_{y}(t)^{j}t^{k}, and transmits the generated equation to the linear simultaneous equation solving unit 209.

The linear simultaneous equation solving unit 209 solves this linear simultaneous equation based on a matrix operation and outputs a solution to the decrypting unit 204.

The decrypting unit 204 restores this solution into a form of a message to generate a plaintext candidate M (ST19). This restoration method is as explained above.

Then, the decrypting unit 204 transmits the plaintext candidate M to the plaintext inspecting unit 210. The plaintext inspecting unit 210 inspects an error detection code contained in the plaintext candidate M (ST20), and transmits an inspection result to the decrypting unit 204. When the inspection result obtained at step ST20 indicates rejection, the decrypting unit 204 judges whether there is another identification polynomial candidate (ST21). If there is another candidate, the decrypting unit 204 determines the next identification candidate polynomial candidate as f(uₓ(t),u_{y}(t),t) and repeats steps ST18 to ST20. If there is no identification polynomial candidate as a result of the judgment at step ST21, the decrypting unit 204 outputs an error (ST23) to terminate the processing.

On the other hand, when the inspection result at step ST20 indicates acceptance, the decrypting unit 204 determines the plaintext candidate M as a correct plaintext m and outputs this plaintext from the output unit 211.

After these operations, the decryption apparatus 200 terminates the decryption processing.

(Key Generation Processing)

Generation of an algebraic surface will be first explained, and then generation of a format of a plaintext polynomial will be described.

[Generation of Algebraic Surface]

As shown in FIG. 7, when a basic format of an algebraic surface X is input from the input unit 303 (ST31), the key generation apparatus 300 starts processing. The basic format of the algebraic surface X is represented by the following expression.

$$X ( x , y , t ) = {\sum }_{( i , j ) ∈ {Λ}_{X}} {a}_{ij} ( t ) {x}^{i} {y}^{j}$$

Input data is constituted of each element of Λ_{X} and a degree of each coefficient aᵢⱼ(t) associated with the element of Λ_{X}. The input unit 303 temporarily stores the basic format of the algebraic surface in the memory 302, and transmits the basic form of the algebraic surface in the memory 302 to the control unit 304.

Upon receiving the basic format of the algebraic surface, the control unit 304 reads a prime number p and a maximum degree d of a section as fixed parameters from the fixed parameter storage unit 301 (ST32, ST33), and transmits these fixed parameters p and d to the section generating unit 305.

The section generating unit 305 uses the one-variable polynomial generating unit 306 to generate one-variable polynomials uₓ(t) and u_{y}(t) each having a degree d on a prime field Fₚ, and generates a section D:(x,y,t)=(uₓ(t),u_{y}(t),t) from the two one-variable polynomials uₓ(t) and u_{y}(t) to be transmitted to the control unit 304 (ST34).

The control unit 304 transmits this section D, and the basic format of the algebraic surface and the prime number p in the memory 302 to the algebraic surface generating unit 307.

Upon receiving the section D, the basic format of the algebraic surface, and the prime number p, the algebraic surface generating unit 307 randomly generates aᵢⱼ(t) other than constant terms (ST35). Further, the algebraic surface generating unit 307 assigns the section D:(x,y,t)=(uₓ(t),u_{y}(t),t) to portions other than constant terms of the algebraic surface, and provides an assignment result with a negative sign to produce a constant term a₀₀(t) (ST36), thereby producing an algebraic surface formed of portions other than the constant term and the constant term a₀₀(t). It is to be noted that an instruction is supplied to the polynomial arithmetic unit 308 at the time of this calculation to perform adding/subtracting/multiplying operations. Moreover, the algebraic surface X generated in this example is a fibration X(x,y,t) in the algebraic surface X.

The produced algebraic surface X is transmitted to the control unit 304 from the algebraic surface generating unit 307. The control unit 304 outputs the algebraic surface X from the output unit 312 (ST37).

[Generation of Format of Plaintext Polynomial]

As shown in FIG. 8, when a basic format of a plaintext polynomial m(x,y,t) and a section (x,y,t)=(uₓ(t),u_{y}(t),t) are input from the input unit 303 (ST41, ST42), the key generation apparatus 300 starts processing. The basic format of the plaintext polynomial is represented by the following expression.

$$m ( x , y , t ) = {\sum }_{( i , j ) ∈ {Λ}_{m}} {m}_{ij} ( t ) {x}^{i} {y}^{j}$$

Input data is constituted of elements of Λₘ and degrees of respective coefficients mᵢⱼ(t) associated with the elements of Λₘ. The input unit 303 temporarily stores a basic format of a plaintext polynomial and a section in the memory 302, and supplies the basic format of the plaintext polynomial in the memory 302 to the control unit 304.

Upon receiving the basic format of the plaintext polynomial, the control unit 304 reads a prime number p as a fixed parameter from the fixed parameter storage unit 301 (ST43). The control unit 304 transmits data of the basic format of the plaintext polynomial and the prime number p to the plaintext polynomial generating unit 309.

The plaintext polynomial generating unit 309 assigns a section (x,y,t)=(uₓ(t),u_{y}(t),t) in the memory 302 to this basic format of the plaintext polynomial to calculate m(uₓ(t),u_{y}(t),t) in the following expression (ST44).

$$m ( x , y , t ) = {\sum }_{( i , j , k ) ∈ {Γ}_{m}} {m}_{ijk} {{u}_{x} ( t )}^{i} {{u}_{y} ( t )}^{j} {t}^{k}$$

Here, mᵢⱼₖ is a variable. The plaintext polynomial generating unit 309 sequences the variables mᵢₗₖ to generate a variable vector (m₀₀₀ m₀₀₁, . . . , mᵢⱼₖ, . . . ) (ST45), and transmits the variable vector (m₀₀₀, m₀₀₁, . . . , mᵢⱼₖ, . . . ) and a one-variable polynomial m(uₓ(t),u_{y}(t),t) to the matrix generating unit 310.

The matrix generating unit 310 organizes m(uₓ(t),u_{y}(t),t) in regard to a variable t and generates a coefficient matrix A representing a coefficient mᵢⱼₖuₓ(t)ⁱu_{y}(t)j containing the variable mᵢⱼₖ using the variable vector (m₀₀₀, m₀₀₁, . . . , mᵢⱼₖ, . . . ) (ST46). Specifically, the matrix generating unit 310 extracts a polynomial in which t has a coefficient mᵢⱼₖuₓ(t)ⁱu_{y}(t)j from the polynomial organized in relation to the variable t and generates the coefficient matrix in such a manner that a product obtained from the variable vector (m₀₀₀, m₀₀₁, . . . , mᵢⱼₖ, . . . ) precisely becomes the coefficient mᵢⱼₖuₓ(t)ⁱu_{y}(t)^{j} of t. The generated coefficient matrix A is transmitted to the plaintext polynomial generating unit 309 from the matrix generating unit 310.

The plaintext polynomial generating unit 309 supplies an instruction for calculating a rank of this coefficient matrix A to the rank arithmetic unit 311. The rank arithmetic unit 311 calculates a rank of the coefficient matrix A in response to this instruction and supplies this rank to the plaintext polynomial generating unit 309 (ST47).

The plaintext polynomial generating unit 309 compares this rank with a degree number of the variable vector to judge whether the rank is equal to or below the degree number of the variable vector (ST48).

If the rank is not equal to or below the degree number as a result of this judgment, since a unique solution cannot be obtained, the plaintext polynomial generating unit 309 determines some of the variables mᵢⱼₖ as constants (ST49) and again executes the processing from the calculation of the rank at step ST47. Further, if the rank is equal to or below the degree number of the vector as a result of the judgment at step ST48, since a unique solution can be obtained, a format of the plaintext polynomial m(x,y,t) associated with the one-variable polynomial m(uₓ(t),u_{y}(t),t) is input to the control unit 304.

The control unit 304 outputs a format of the plaintext polynomial m(x,y,t) from the output unit 312 (ST50).

With the above-explained operations, the key generation apparatus 300 terminates the key generation processing.

As explained above, according to this embodiment, as different from the conventional example using a one-variable plaintext polynomial m(t) and an irreducible polynomial f(t), adopting a structure utilizing a three-variable plaintext polynomial m(x,y,t) and an identification polynomial f(x,y,t) enables eliminating weakness caused due to a one-variable polynomial in the public key cryptography using an algebraic surface.

### Variation of This Embodiment

A first variation can be realized by creating an encrypted text based on, e.g., the following expression in place of Expression (6) by the encrypting unit 107 at steps ST7 and ST8.

F(x,y,t)=m(x,y,t)−f(x,y,t)s(x,y,t)−X(x,y,t)r(x,y,t)

On the other hand, decryption processing can be likewise realized by performing axiomatic modification in accordance with an encryption arithmetic operation in this variation.

A second variation can be realized by adding an irreducibility judgment function of judging irreducibility to the identification polynomial generating unit 106 in the encryption apparatus 100, judging whether an identification polynomial f(x,y,t) generated at step ST5 is an irreducible polynomial, and repeating the processing at step ST5 when the identification polynomial is not an irreducible polynomial. As a judgment on irreducibility, it is good enough to judge whether an identification polynomial f(x,y,t) can be factorized, determine that the identification polynomial is not an irreducible polynomial to annul the identification polynomial if factorization is possible as a result of the judgment, and determine that the identification polynomial is an irreducible polynomial if factorization is impossible as a result of the judgment, for example.

A third variation can be realized when the plaintext embedding unit 104 executes processing of dividing a plaintext m to be embedded in a coefficient of a plaintext polynomial m(x,y,t) and a coefficient of an identification polynomial f(x,y,t) in place of processing of embedding the plaintext m in a plaintext polynomial m(x,y,t) at step ST4 in the encryption processing. In this case, in decryption processing, a plaintext candidate M can be generated by solving a linear simultaneous equation that is produced when a coefficient of a plaintext polynomial m(uₓ(t),u_{y}(t),t) is compared with that of a plaintext polynomial candidate M with a coefficient of the plaintext polynomial m(x,y,t) being determined as a variable, and the same processing as that performed to obtain the plaintext m can be executed with respect to the identification polynomial f(x,y,t). That is, in the decryption processing, like the decryption processing from a plaintext polynomial, a plaintext candidate M can be generated by solving a linear simultaneous equation produced when a coefficient of an identification polynomial f(uₓ(t),u_{y}(t),t) is compared with that of an identification polynomial candidate M with a coefficient of the identification polynomial f(x,y,t) being determined as a variable, thereby obtaining a plaintext m. Moreover, in case of also adopting the second variation, when embedding a plaintext m in each identification polynomial f(x,y,t), it is good enough to execute a method of embedding the plaintext m in coefficients in some of f(x,y,t) and adjusting to form an irreducible polynomial with remaining coefficients.

In regard to a fourth variation, when the polynomial generating unit 107 generates polynomials r(x,y,t) and s(x,y,t) at step ST6, it is good enough to satisfy the conditions that X(x,y,t)r(x,y,t) and f(x,y,t)s(x,y,t) include the same like term as a polynomial of x and y and that degrees of one-variable polynomials containing t which is a coefficient of a polynomial of x and y as a variable match with each other. The conditions can be satisfied by matching a format of one polynomial r(x,y,t) with a format of an identification polynomial f(x,y,t) and matching a format of the other polynomial s(x,y,t) with a format of a fibration X(x,y,t) to produce the polynomials r(x,y,t) and s(x,y,t). Specifically, it is good enough to generate the polynomial r(x,y,t) in such a manner that each term has the same degree of x and y as a degree of x and y of each term in the identification polynomial f(x,y,t) and produce the polynomial s(x,y,t) in such a manner that each term has the same degree of x and y as a degree of x and y of each term in the fibration X(x,y,t).

In regard to a fifth variation, in a period between steps ST16 and ST17 in the decryption processing, a value k of a non-illustrated counter is set to zero, a plaintext candidate M is stored in the memory 202 when a result of the inspection at step ST20 is acceptable, the value k of the counter is incremented by “+1”, and the same processing is performed with respect to the next candidate f(uₓ(t),u_{y}(t),t) from step ST18. When there is no next candidate f(uₓ(t),u_{y}(t),t), an error is output in a case where the value k of the counter is two or above or equal to zero, and the plaintext candidate M in the memory 202 is output as the plaintext m when the value k of the counter is one. The fifth variation can be realized as explained above.

In regard to a sixth variation, steps ST13 to ST22 (however, ST20 is omitted) in the decryption processing are repeated for the number of the sections D, a set Mₙ of plaintext candidates associated with the respective sections Dₙ is obtained, and the plaintext candidates included in this set Mₙ are stored in the memory 202. Thereafter, a plaintext candidate common to the plaintext candidate set Mₙ is output to the output unit 211 as the plaintext m.

Supplementarily, at steps ST13 and ST14 in the sixth variation, the section assigning unit 205 assigns respective sections D₁, . . . , Dₙ to input encrypted texts F₁(x,y,t) and F₂(x,y,t) to generate two one-variable polynomials {h₁₁(t), h₂₁(t)}, . . . , {h₁ₙ(t),h₂ₙ(t)}. These one-variable polynomials {h₁₁(t),h₂₁(t)}, . . . , {h₁ₙ(t)h₂ₙ(t)} are supplied to the decrypting unit 204 to the section assigning unit 205.

The decrypting section 204 acquires subtraction results {h₁₁(t)−h₂₁(t)}, . . . , {h₁ₙ(t)−h₂ₙ(t)} obtained as a result of subtraction in regard to the respective one-variable polynomials {h₁₁(t), h₂₁(t)}, . . . , {h₁ₙ(t),h₂ₙ(t)} by transmitting the respective one-variable polynomials {h₁₁(t),h₂₁(t)}, . . . , {h₁ₙ(t),h₂ₙ(t)} to the one-variable polynomial arithmetic unit 206 where they are subjected to subtraction.

At step ST15, the decrypting unit 204 transmits the subtraction results {h₁₁(t)−h₂₁(t)}, . . . , {h₁ₙ(t)−h₂ₙ(t)} to the one-variable polynomial factorizing unit 207 to be factorized.

The one-variable polynomial factorizing unit 207 transmits a result of factorization to the decrypting unit 204 as an alignment in which factors are sequenced.

At step ST16, the decrypting unit 204 combines factors generated as a result of factorization to extract all identification polynomial candidates f(uₓ(t),u_{y}(t),t) each precisely having deg f(uₓ(t),u_{y}(t),t) as a degree.

At step ST17, the decrypting unit 204 sequentially extracts the candidates for the identification polynomial f(uₓ(t),u_{y}(t),t) and sequentially transmits them together with h₁₁(t), . . . , h₁ₙ(t) to the one-variable polynomial residue arithmetic unit 208.

At step ST18, the one-variable polynomial residue arithmetic unit 208 divides each of the one-variable polynomials h₁₁(t), . . . , h₁ₙ(t) by the identification polynomial candidate f(uₓ(t),u_{y}(t),t), and transmits a plaintext polynomial candidate m(uₓ(t),u_{y}(t),t) obtained as a residue to the decrypting unit 204.

Like the above explanation, the decrypting unit 204 derives a linear simultaneous equation having a coefficient of the plaintext polynomial m(x,y,t) as a variable based on the plaintext polynomial candidate m(uₓ(t),u_{y}(t),t) and a previously disclosed format of the plaintext polynomial m(x,y,t).

At step ST19, when the linear simultaneous equation solving unit 209 solves this linear simultaneous equation, the decrypting unit 204 generates each plaintext candidate M from this solution. This plaintext candidate M is transmitted to the plaintext inspecting unit 210 from the decrypting unit 204.

At step ST20, the plaintext inspecting unit 210 judges whether there is a common plaintext candidate M in n plaintext candidates M obtained from n plaintext polynomial candidates m(uₓ(t),u_{y}(t),t) acquired by dividing each of the one-variable polynomials h₁₁(t), . . . , h₁ₙ(t).

At step ST24, the decrypting unit 204 outputs the common plaintext candidate M to the output unit 211 as a plaintext when there is the common plaintext candidate M as a result of the judgment performed by the plaintext inspecting unit 210.

The sixth variation can be realized as explained above. It is to be noted that, when there are a plurality of plaintext candidates, an error may be output. In this case, however, when the fifth variation is also adopted and inspection of an error detection code is used for the plurality of plaintext candidates to narrow down the plaintext candidates, the sixth variation can be highly possibly carried out while avoiding output of an error.

The technique described above for the embodiment can be stored as a program to be executed by a computer in memory mediums including magnetic disks (Floppy™ disks, hard disks, etc.), optical disks (CD-ROMs, DVDs, etc.), magneto-optical disks (MOs) and semiconductor memories for distribution.

Memory mediums that can be used for the purpose of the present invention are not limited to those listed above and memory mediums of any type can also be used for the purpose of the present invention so long as they are computer-readable ones.

Additionally, the operating system (OS) operating on a computer according to the instructions of a program installed in the computer from a memory medium, data base management software and/or middleware such as network software may take part in each of the processes for realizing the above embodiment.

Still additionally, memory mediums that can be used for the purpose of the present invention are not limited to those independent from computers but include memory mediums adapted to download a program transmitted by LANs and/or the Internet and permanently or temporarily store it.

It is not necessary that a single memory medium is used with the above described embodiment. In other words, a plurality of memory mediums may be used with the above-described embodiment to execute any of the above described various processes. Such memory mediums may have any configuration.

For the purpose of the present invention, a computer executes various processes according to one or more than one programs stored in the memory medium or mediums as described above for the preferred embodiment. More specifically, the computer may be a stand alone computer or a system realized by connecting a plurality of computers by way of a network.

For the purpose of the present invention, computers include not only personal computers but also processors and microcomputers contained in information processing apparatus. In other words, computers generally refer to apparatus and appliances that can realize the functional features of the present invention by means of a computer program.

The present invention is by no means limited to the above described embodiment, which may be modified in various different ways without departing from the spirit and scope of the invention. Additionally, any of the components of the above described embodiment may be combined differently in various appropriate ways for the purpose of the present invention. For example, some of the components of the above described embodiment may be omitted. Alternatively, components of different embodiments may be combined appropriately in various different ways for the purpose of the present invention.

What is claimed is:

1. An encryption apparatus comprising:
a plaintext embedding device configured to embed a message m as a coefficient of a plaintext polynomial m(x,y,t) having three variables when encrypting the message m if a fibration X(x,y,t) of an algebraic surface X is a public key and two or more sections corresponding to the fibration X(x,y,t) are private keys;
an identification polynomial generation device configured to generate an identification polynomial f(x,y,t) having three variables in such a manner that a degree of a one-variable polynomial obtained when assigning the sections becomes higher than a degree of a one-variable polynomial obtained by assigning the sections to the plaintext polynomial;
a polynomial generation device configured to randomly generate three-variable polynomials r₁(x,y,t), r₂(x,y,t), s₁(x,y,t), and s₂(x,y,t);
a first encryption device configured to generate a first encrypted text F₁=Eₚₖ(m,s₁,r₁,f,X) from the plaintext polynomial m(x,y,t) by processing of executing addition or subtraction using a multiplication result f(x,y,t)s₁(x,y,t) of the identification polynomial f(x,y,t) and the polynomial s₁(x,y,t) and a multiplication result X(x,y,t)r₁(x,y,t) of the fibration X(x,y,t) and the polynomial r₁(x,y,t); and
a second encryption device configured to generate a second encrypted text F₂=Eₚₖ(m,s₂,r₂,f,X) from the plaintext polynomial m(x,y,t) by processing of executing addition or subtraction using a multiplication result f(x,y,t)s₂(x,y,t) of the identification polynomial f(x,y,t) and the polynomial s₂(x,y,t) and a multiplication result X(x,y,t)r₂(x,y,t) of the fibration X(x,y,t) and the polynomial r₂(x,y,t).

2. The apparatus according to claim 1,
wherein the plaintext embedding device divides the message m to be embedded in the coefficient of the plaintext polynomial m(x,y,t) having three variables and a coefficient of the identification polynomial f(x,y,t).

3. The apparatus according to claim 2,
wherein the polynomial generation device comprises:
a first polynomial generation device configured to generate the polynomial r₁(x,y,t) in such a manner that each term has the same degree of x and y as that of x and y of each term in the identification polynomial and generate the polynomial s₁(x,y,t) in such a manner that each term has the same degree of x and y as that of x and y of each term in the fibration X(x,y,t); and
a second polynomial generation device configured to generate the polynomial r₂(x,y,t) in such a manner that each term has the same degree of x and y as that of x and y of each term in the identification polynomial f(x,y,t) and generate the polynomial s₂(x,y,t) in such a manner that each term has the same degree of x and y as that of x and y of each term in the fibration X(x,y,t).

4. The apparatus according to claim 3,
wherein the identification polynomial generation device further restricts a range of a polynomial generated as the identification polynomial f(x,y,t) to a range where a polynomial becomes an irreducible polynomial.

5. The apparatus according to claim 1,
wherein the polynomial generation device comprises:
a first polynomial generation device configured to generate the polynomial r₁(x,y,t) in such a manner that each term has the same degree of x and y as that of x and y of each term in the identification polynomial and generate the polynomial s₁(x,y,t) in such a manner that each term has the same degree of x and y as that of x and y of each term in the fibration X(x,y,t); and
a second polynomial generation device configured to generate the polynomial r₂(x,y,t) in such a manner that each term has the same degree of x and y as that of x and y of each term in the identification polynomial f(x,y,t) and generate the polynomial s₂(x,y,t) in such a manner that each term has the same degree of x and y as that of x and y of each term in the fibration X(x,y,t).

6. The apparatus according to claim 5,
wherein the identification polynomial generation device further restricts a range of a polynomial generated as the identification polynomial f(x,y,t) to a range where a polynomial becomes an irreducible polynomial.

7. The apparatus according to claim 1,
wherein the identification polynomial generation device further restricts a range of a polynomial generated as the identification polynomial f(x,y,t) to a range where a polynomial becomes an irreducible polynomial.

8. The apparatus according to claim 2,
wherein the identification polynomial generation device further restricts a range of a polynomial generated as the identification polynomial f(x,y,t) to a range where a polynomial becomes an irreducible polynomial.

9. A decryption apparatus comprising:
a first input device configured to input a first encrypted text F₁(x,y,t)=Eₚₖ(m,s₁,r₁,f,X) generated by processing of executing addition or subtraction using a multiplication result f(x,y,t)s₁(x,y,t) of a three-variable identification polynomial f(x,y,t) and a polynomial s₁(x,y,t) and a multiplication result X(x,y,t)r₁(x,y,t) of a fibration X(x,y,t) and a polynomial r₁(x,y,t) with respect to a three-variable plaintext polynomial m(x,y,t) in which a message m is embedded as a coefficient thereof in case of decrypting the message m from the first and second encrypted texts F₁(x,y,t) and F₂(x,y,t) generated by using a public key as the fibration X(x,y,t) based on a private key as one or more sections corresponding to the fibration X(x,y,t) of an algebraic surface X;
a second input device configured to input the second encrypted text F₂(x,y,t)=Eₚₖ(m,s₂,r₂,f,X) generated by processing of executing addition or subtraction using a multiplication result f(x,y,t)s₂(x,y,t) of the three-variable identification polynomial f(x,y,t) and a polynomial s₂(x,y,t) and a multiplication result X(x,y,t)r₂(x,y,t) of the fibration X(x,y,t) and a polynomial r₂(x,y,t) with respect to the plaintext polynomial m(x,y,t);
a section assignment device configured to assign the respective sections to the input respective encrypted texts F₁(x,y,t) and F₂(x,y,t) to generate two one-variable polynomials h₁(t) and h₂(t);
a polynomial subtraction device configured to subtract the respective one-variable polynomials h₁(t) and h₂(t) to obtain a subtraction result {h₁(t)−h₂(t)};
a factorization device configured to factorize the subtraction result {h₁(t)−h₂(t)};
a polynomial extraction device configured to extract all identification polynomial candidates f(uₓ(t),u_{y}(t),t) each precisely having a degree deg f(uₓ(t),u_{y}(t),t) by combining factors generated as a result of the factorization;
a residue arithmetic device configured to divide the one-variable polynomial h₁(t) by each identification polynomial candidate f(uₓ(t),u_{y}(t),t) to obtain a plaintext polynomial candidate m(uₓ(t),u_{y}(t),t) as a residue;
a plaintext candidate generation device configured to derive a linear simultaneous equation having a coefficient of the plaintext polynomial m(x,y,t) as a variable based on the plaintext polynomial candidate f(uₓ(t),u_{y}(t),t) and a previously disclosed format of the plaintext polynomial m(x,y,t) and solve the linear simultaneous equation to generate a plaintext candidate M;
a plaintext polynomial inspection device configured to inspect whether the polynomial candidate M is a true plaintext based on an error detection code included therein; and
an output device configured to output the plaintext candidate M as a plaintext when the plaintext candidate M as the true plaintext is present as a result of the inspection.

10. The apparatus according to claim 9,
wherein the message m is divided to be embedded in the coefficient of the three-variable plaintext polynomial m(x,y,t) and a coefficient of the three-variable identification polynomial f(x,y,t), and
the plaintext candidate generation device comprises:
a first candidate generation device configured to derive a linear simultaneous equation having the coefficient of the plaintext polynomial m(x,y,t) as a variable based on the plaintext polynomial candidate m(uₓ(t),u_{y}(t),t) and the previously disclosed format of the plaintext polynomial m(x,y,t) and solve the linear simultaneous equation to generate the plaintext candidate M; and
a second candidate generation device configured to derive a linear simultaneous equation having the coefficient of the identification polynomial f(x,y,t) as a variable based on the identification polynomial candidate f(uₓ(t),u_{y}(t),t) and a previously disclosed format of the identification polynomial f(x,y,t) and solve the linear simultaneous equation to generate the plaintext candidate M.

11. A decryption apparatus comprising:
a first input device configured to input a first encrypted text F₁(x,y,t)=Eₚₖ(m,s₁,r₁,f,X) generated by processing of executing addition or subtraction using a multiplication result f(x,y,t)s₁(x,y,t) of a three-variable identification polynomial f(x,y,t) and a polynomial s₁(x,y,t) and a multiplication result X(x,y,t)r₁(x,y,t) of a fibration X(x,y,t) and a polynomial r₁(x,y,t) with respect to a three-variable plaintext polynomial m(x,y,t) in which a message m is embedded as a coefficient thereof in case of decrypting the message m from the first and second encrypted texts F₁(x,y,t) and F₂(x,y,t) generated by using a public key as the fibration X(x,y,t) based on a private key as n sections D₁, . . . , Dₙ corresponding to the fibration X(x,y,t);
a second input device configured to input the second encrypted text F₂(x,y,t)=Eₚₖ(m,s₂,r₂,f,X) generated by processing of executing addition or subtraction using a multiplication result f(x,y,t)s₂(x,y,t) of the three-variable identification polynomial f(x,y,t) and a polynomial s₂(x,y,t) and a multiplication result X(x,y,t)r₂(x,y,t) of the fibration X(x,y,t) and a polynomial r₂(x,y,t) with respect to the plaintext polynomial m(x,y,t);
a section assignment device configured to assign the respective sections D₁, . . . , Dₙ to the input respective encrypted texts F₁(x,y,t) and F₂(x,y,t) to generate two one-variable polynomials {h₁₁(t),h₂₁(t)}, . . . , {h₁ₙ(t),h₂ₙ(t)};
a polynomial subtraction device configured to subtract the respective one-variable polynomials {h₁₁(t),h₂₁(t)}, . . . , {h₁ₙ(t),h₂ₙ(t)} to obtain subtraction results {h₁₁(t)−h₂₁(t)}, . . . , {h₁ₙ(t)−h₂ₙ(t));
a factorization device configured to factorize the subtraction results (h₁₁(t)−h₂₁(t)}, . . . , {h₁ₙ(t)−h₂ₙ(t)};
a polynomial extraction device configured to extract all identification polynomial candidates f(uₓ(t),u_{y}(t),t) each precisely having a degree deg f(uₓ(t),u_{y}(t),t) by combining factors generated as a result of the factorization;
a residue arithmetic device configured to divide each of the one-variable polynomial h₁₁(t), . . . , h₁ₙ(t) by each identification polynomials candidate f(uₓ(t),u_{y}(t),t) to obtain n plaintext polynomial candidates m(uₓ(t),u_{y}(t),t) as residues;
a plaintext candidate generation device configured to derive a linear simultaneous equation having a coefficient of the plaintext polynomial m(x,y,t) as a variable based on the plaintext polynomial candidate m(uₓ(t),u_{y}(t),t) and a previously disclosed format of the plaintext polynomial m(x,y,t) and solve the linear simultaneous equation to generate a plaintext candidate M;
a common candidate judgment device configured to judge whether there is a plaintext candidate M common to n plaintext candidates M obtained from the n plaintext polynomial candidates m(uₓ(t),u_{y}(t),t) acquired by respectively dividing the one-variable polynomials h₁₁(t), . . . , h₁ₙ(t); and
an output device configured to output the common plaintext candidate M when the common plaintext candidate M is present as a result of the inspection.

12. The apparatus according to claim 11,
wherein the message m is divided to be embedded in the coefficient of the three-variable plaintext polynomial m(x,y,t) and a coefficient of the three-variable identification polynomial f(x,y,t),
the plaintext candidate generation device comprises:
a first candidate generation device configured to derive a linear simultaneous equation having the coefficient of the plaintext polynomial m(x,y,t) as a variable based on the plaintext polynomial candidate m(uₓ(t),u_{y}(t),t) and the previously disclosed format of the plaintext polynomial m(x,y,t) and solve the linear simultaneous equation to generate the plaintext candidate M; and
a second candidate generation device configured to derive a linear simultaneous equation having the coefficient of the identification polynomial f(x,y,t) as a variable based on the identification polynomial candidate f(uₓ(t),u_{y}(t),t) and a previously disclosed format of the identification polynomial f(x,y,t) and solve the linear simultaneous equation to generate the plaintext candidate M, and
the common candidate judgment device judges whether there is a plaintext candidate M common to the respective plaintext candidates M obtained by the first and second candidate generation devices.

13. A key generation apparatus comprising:
a section generation device configured to randomly generate one or more sections, the sections being private keys corresponding to a fibration X(x,y,t) of an algebraic surface X;
a coefficient generation device configured to randomly generating a coefficient of a term other than a constant term when the fibration X(x,y,t) is regarded as a polynomial of variables x and y and thereby produce the term other than the constant term in a case where the fibration X(x,y,t) is a public key;
a fibration generation device configured to calculate the constant term by giving a negative sign to an assignment result obtained by assigning the sections to the term other than the constant term and generate the fibration X(x,y,t) constituted of the term other than the constant term and the constant term;
a section assignment device configured to assign the sections to a basic format of a plaintext polynomial having a coefficient mᵢⱼₖ as a variable when generating a format of the plaintext polynomial in which a message m is embedded;
a device configured to sequence each variable mᵢⱼₖ obtained as a result of the assignment to generate a variable vector (m₀₀₀, m₀₀₁, . . . , mᵢⱼₖ, . . . );
a coefficient extraction device configured to organize each one-variable polynomial m(uₓ(t),u_{y}(t),t) obtained as a result of the assignment in regard to t to extract a polynomial having a coefficient mᵢⱼₖuₓ(t)ⁱu_{y}(t)^{j} of t;
a coefficient matrix generation device configured to generate a coefficient matrix in such a manner that a product obtained from the variable vector (m₀₀₀, m₀₀₁, . . . , mᵢⱼₖ, . . . ) precisely becomes the coefficient mᵢⱼₖuₓ(t)ⁱu_{y}(t)^{j} of t;
a coefficient matrix calculation device configured to calculate a rank of the coefficient matrix;
a variable adjustment device configured to set the variables mᵢⱼₖ in some of the one-variable polynomials m(uₓ(t),u_{y}(t),t) to constants when the rank is higher than a degree number of the variable vector; and
an output device configured to output a format of a three-variable polynomial m(x,y,t) corresponding to the one-variable polynomial m(uₓ(t),u_{y}(t),t) when the rank is equal to or lower than the degree number of the variable vector as a format of the plaintext polynomial.

14. A program stored in a computer-readable storage medium, comprising:
first program code that allows the computer to execute processing of embedding a message m as a coefficient of a three-variable plaintext polynomial m(x,y,t) when encrypting the message m if a fibration X(x,y,t) of an algebraic surface X is a public key and two or more sections corresponding to the fibration X(x,y,t) are private keys;
second program code that allows the computer to execute processing of writing the plaintext polynomial m(x,y,t) having the coefficient embedded therein in a memory of the computer;
third program code that allows the computer to execute processing of generating a three-variable identification polynomial f(x,y,t) in such a manner that a degree of a one-variable polynomial obtained when assigning the sections becomes higher than a degree of a one-variable polynomial obtained when assigning sections to the plaintext polynomial;
fourth program code that allows the computer to execute processing of randomly generating three-variable polynomials r₁(x,y,t), r₂(x,y,t), s₁(x,y,t), and s₂(x,y,t);
fifth program code that allows the computer to execute processing of generating a first encrypted text F₁(x,y,t)=Eₚₖ(m,s₁,r₁,f,X) from the plaintext polynomial m(x,y,t) in the memory by processing of executing addition or subtraction using a multiplication result f(x,y,t)s₁(x,y,t) of the identification polynomial f(x,y,t) and a polynomial s1(x,y,t) and a multiplication result X(x,y,t)r₁(x,y,t) of the fibration X(x,y,t) and a polynomial r₁(x,y,t); and
sixth program code that allows the computer to execute processing of generating a second encrypted text F₂(x,y,t)=Eₚₖ(m,s₂,r₂,f,X) from the plaintext polynomial m(x,y,t) in the memory by processing of executing addition or subtraction using a multiplication result f(x,y,t)s₂(x,y,t) of the identification polynomial f(x,y,t) and a polynomial s2(x,y,t) and a multiplication result X(x,y,t)r₂(x,y,t) of the fibration X(x,y,t) and a polynomial r₂(x,y,t).

15. The program according to claim 14,
wherein the first program code is code that allows the computer to execute processing of dividing the message m to be embedded in the coefficient of the three-variable plaintext polynomial m(x,y,t) and a coefficient of the three-variable identification polynomial f(x,y,t).

16. The program according to claim 15,
wherein the fourth program code comprises:
seventh program code that allows the computer to execute processing of generating the polynomial r₁(x,y,t) in such a manner that each term has the same degree of x and y as a degree of x and y of each term in the identification polynomial f(x,y,t) and generating the polynomial s₁(x,y,t) in such a manner that each term has the same degree of x and y as a degree of x and y of each term in the fibration X(x,y,t); and
eighth program code that allows the computer to execute a processing of generating the polynomial r₂(x,y,t) in such a manner that each term has the same degree of x and y as a degree of x and y of each term in the identification polynomial f(x,y,t) and generating the polynomial s₂(x,y,t) in such a manner that each term has the same degree of x and y as a degree of x and y of each term in the fibration X(x,y,t).

17. The program according to claim 16,
wherein the third program code comprises a ninth program code that allows the computer to execute processing of annulling the identification polynomial f(x,y,t) and re-executing processing of generating the identification polynomial f(x,y,t) to further restrict a range of a polynomial generated as the identification polynomial f(x,y,t) to a range of an irreducible polynomial when the identification polynomial f(x,y,t) that cannot be factorized is generated.

18. The program according to claim 14,
wherein the fourth program code comprises:
seventh program code that allows the computer to execute processing of generating the polynomial r₁(x,y,t) in such a manner that each term has the same degree of x and y as a degree of x and y of each term in the identification polynomial f(x,y,t) and generating the polynomial s₁(x,y,t) in such a manner that each term has the same degree of x and y as a degree of x and y of each term in the fibration X(x,y,t); and
eighth program code that allows the computer to execute a processing of generating the polynomial r₂(x,y,t) in such a manner that each term has the same degree of x and y as a degree of x and y of each term in the identification polynomial f(x,y,t) and generating the polynomial s₂(x,y,t) in such a manner that each term has the same degree of x and y as a degree of x and y of each term in the fibration X(x,y,t).

19. The program according to claim 18,
wherein the third program code comprises a ninth program code that allows the computer to execute processing of annulling the identification polynomial f(x,y,t) and re-executing processing of generating the identification polynomial f(x,y,t) to further restrict a range of a polynomial generated as the identification polynomial f(x,y,t) to a range of an irreducible polynomial when the identification polynomial f(x,y,t) that cannot be factorized is generated.

20. The program according to claim 14,
wherein the third program code comprises a ninth program code that allows the computer to execute processing of annulling the identification polynomial f(x,y,t) and re-executing processing of generating the identification polynomial f(x,y,t) to further restrict a range of a polynomial generated as the identification polynomial f(x,y,t) to a range of an irreducible polynomial when the identification polynomial f(x,y,t) that cannot be factorized is generated.

21. The program according to claim 15,
wherein the third program code comprises a ninth program code that allows the computer to execute processing of annulling the identification polynomial f(x,y,t) and re-executing processing of generating the identification polynomial f(x,y,t) to further restrict a range of a polynomial generated as the identification polynomial f(x,y,t) to a range of an irreducible polynomial when the identification polynomial f(x,y,t) that cannot be factorized is generated.

22. A program stored in a computer-readable storage medium, comprising:
first program code that allows the computer to execute processing of accepting input of a first encrypted text F₁(x,y,t)=Eₚₖ(m,s₁,r₁,f,X) generated by processing of executing addition or subtraction using a multiplication result f(x,y,t)s₁(x,y,t) of a three-variable identification polynomial f(x,y,t) and a polynomial s₁(x,y,t) and a multiplication result X(x,y,t)r₁(x,y,t) of a fibration X(x,y,t) and a polynomial r₁(x,y,t) with respect to a three-variable plaintext polynomial m(x,y,t) in which a message m is embedded as a coefficient in case of decrypting the message m from the first and second encrypted texts F₁(x,y,t) and F₂(x,y,t) generated by using a public key as the fibration X(x,y,t) based on a private key as one or more sections corresponding to the fibration X(x,y,t) of an algebraic surface X;
second program code that allows the computer to execute processing of accepting input of the second encrypted text F₂(x,y,t)=Eₚₖ(m,s₂,r₂,f,X) generated by processing of executing addition or subtraction using a multiplication result f(x,y,t)s₂(x,y,t) of the three-variable identification polynomial f(x,y,t) and a polynomial s₂(x,y,t) and a multiplication result X(x,y,t)r₂(x,y,t) of the fibration X(x,y,t) and a polynomial r₂(x,y,t) with respect to the plaintext polynomial m(x,y,t);
third program code that allows the computer to execute processing of writing the input encrypted texts F₁(x,y,t) and F₂(x,y,t) in a memory of the computer;
fourth program code that allows the computer to execute processing of assigning the sections to the respective encrypted texts F₁(x,y,t) and F₂(x,y,t) in the memory to generate two one-variable polynomials h₁(t) and h₂(t);
fifth program code that allows the computer to execute processing of subtracting the respective one-variable polynomials h₁(t) and h₂(t) to obtain a subtraction result {h₁(t)−h₂(t)};
sixth program code that allows the computer to execute processing of factorizing the subtraction result {h₁(t)−h₂(t)};
seventh program code that allows the computer to execute processing of extracting all identification polynomial candidates f(uₓ(t),u_{y}(t),t) each precisely having a degree deg f(uₓ(t),u_{y}(t),t) by combining factors generated as a result of the factorization;
eighth program code that allows the computer to execute processing of dividing the one-variable polynomial h₁(t) by the identification polynomial candidate f(uₓ(t),u_{y}(t),t) to obtain a plaintext polynomial candidate m(uₓ(t),u_{y}(t),t) as a residue;
ninth program code that allows the computer to execute processing of deriving a linear simultaneous equation having a coefficient of the plaintext polynomial m(x,y,t) as a variable based on the plaintext polynomial candidate m(uₓ(t),u_{y}(t),t) and a previously disclosed format of the plaintext polynomial m(x,y,t) and solve the linear simultaneous equation to generate a plaintext candidate M;
tenth program code that allows the computer to execute processing of inspecting whether the plaintext candidate M is a true plaintext based on an error detection code included therein; and
eleventh program code that allows the computer to execute processing of outputting the plaintext candidate M as a plaintext when the plaintext candidate M as the true plaintext is present as a result of the inspection.

23. The program according to claim 22,
wherein the message m is divided to be embedded in the coefficient of the three-variable plaintext polynomial m(x,y,t) and a coefficient of the three-variable identification polynomial f(x,y,t), and
the ninth program code comprises:
twelfth program code that allows the computer to execute processing of deriving a linear simultaneous equation having the coefficient of the plaintext polynomial m(x,y,t) as a variable based on the plaintext polynomial candidate m(uₓ(t),u_{y}(t),t) and a previously disclosed format of the plaintext polynomial m(x,y,t) and solving the linear simultaneous equation to generate a plaintext candidate M; and
thirteenth program code that allows the computer to execute processing of deriving a linear simultaneous equation having the coefficient of the identification polynomial f(x,y,t) as a variable based on the identification polynomial candidate f(uₓ(t),u_{y}(t),t) and a previously disclosed format of the identification polynomial f(x,y,t) and solving the linear simultaneous equation to generate a plaintext candidate M.

24. A program stored in a computer-readable storage medium, comprising:
first program code that allows the computer to execute processing of accepting input of a first encrypted text F₁(x,y,t)=Eₚₖ(m,s₁,r₁,f,X) generated by processing of executing addition or subtraction using a multiplication result f(x,y,t)s₁(x,y,t) of a three-variable identification polynomial f(x,y,t) and a polynomial s₁(x,y,t) and a multiplication result X(x,y,t)r₁(x,y,t) of a fibration X(x,y,t) and a polynomial r₁(x,y,t) with respect to a three-variable plaintext polynomial m(x,y,t) in which a message m is embedded as a coefficient in case of decrypting the message m from the first and second encrypted texts F₁(x,y,t) and F₂(x,y,t) generated by using a public key as the fibration X(x,y,t) based on a private key as n sections D₁, . . . , Dₙ corresponding to the fibration X(x,y,t) of an algebraic surface X;
second program code that allows the computer to execute processing of accepting input of the second encrypted text F₂(x,y,t)=Eₚₖ(m,s₂,r₂,f,X) generated by processing of executing addition or subtraction using a multiplication result f(x,y,t)s₂(x,y,t) of the three-variable identification polynomial f(x,y,t) and a polynomial s₂(x,y,t) and a multiplication result X(x,y,t)r₂(x,y,t) of the fibration X(x,y,t) and a polynomial r₂(x,y,t) with respect to the plaintext polynomial m(x,y,t);
third program code that allows the computer to execute processing of writing the input encrypted texts F₁(x,y,t) and F₂(x,y,t) in a memory of the computer;
fourth program code that allows the computer to execute processing of assigning the sections D₁, . . . , Dₙ to the respective encrypted texts F₁(x,y,t) and F₂(x,y,t) in the memory to generate two one-variable polynomials {h₁₁(t),h₂₁(t)}, . . . , {h₁ₙ(t),h₂ₙ(t)};
fifth program code that allows the computer to execute processing of subtracting the respective one-variable polynomials {h₁₁(t),h₂₁(t)}, . . . {h₁ₙ(t),h₂ₙ(t)} to obtain a subtraction result {h₁₁(t)−h₂₁(t)}, . . . , {h₁ₙ(t)−h₂ₙ(t)};
sixth program code that allows the computer to execute processing of factorizing the subtraction {h₁₁(t)−h₂₁(t)}, . . . {h₁ₙ(t)−h₂ₙ(t)};
seventh program code that allows the computer to execute processing of extracting all identification polynomial candidates f(uₓ(t),u_{y}(t),t) each precisely having a degree deg f(uₓ(t),u_{y}(t),t) by combining factors generated as a result of the factorization;
eighth program code that allows the computer to execute processing of respectively dividing the one-variable polynomials h₁₁(t), . . . , h₁ₙ(t) by each of the identification polynomial candidates f(uₓ(t),u_{y}(t),t) to obtain n plaintext polynomial candidates m(uₓ(t),u_{y}(t),t) as residues;
ninth program code that allows the computer to execute processing of deriving a linear simultaneous equation having a coefficient of the plaintext polynomial m(x,y,t) as a variable based on the plaintext polynomial candidate m(uₓ(t),u_{y}(t),t) and a previously disclosed format of the plaintext polynomial m(x,y,t) and solving the linear simultaneous equation to generate a plaintext candidate M;
tenth program code that allows the computer to execute processing of judging whether there is a plaintext candidate M common to n plaintext candidates M obtained from the n plaintext polynomial candidates m(uₓ(t),u_{y}(t),t) acquired by respectively dividing the one-variable polynomials h₁₁(t), . . . , h₁ₙ(t); and
eleventh program code that allows the computer to execute processing of outputting the common plaintext candidate M as a plaintext when the common plaintext candidate M is present as a result of the judgment.

25. The program according to claim 24,
wherein the message m is divided to be embedded in the coefficient of the three-variable plaintext polynomial m(x,y,t) and a coefficient of the three-variable identification polynomial f(x,y,t), and
the ninth program code comprises:
twelfth program code that allows the computer to execute processing of deriving a linear simultaneous equation having the coefficient of the plaintext polynomial m(x,y,t) as a variable based on the plaintext polynomial candidate m(uₓ(t),u_{y}(t),t) and a previously disclosed format of the plaintext polynomial and solving the linear simultaneous equation to generate the plaintext candidate M; and
thirteenth program code that allows the computer to execute processing of deriving a linear simultaneous equation having the coefficient of the identification polynomial f(x,y,t) as a variable based on the identification polynomial candidate f(uₓ(t),u_{y}(t),t) and a previously disclosed format of the identification polynomial and solving the linear simultaneous equation to generate the plaintext candidate M, and
the 10th program code is code that is used to judge whether there is a plaintext candidate M common to respective plaintext candidates M obtained by execution of the twelfth and thirteenth program codes.

26. A program stored in a computer-readable storage medium, comprising:
first program code that allows the computer to execute processing of writing a prime number p and a maximum degree d of one or more sections in a memory of the computer when the sections corresponding to a fibration X(x,y,t) of an algebraic surface X are private keys;
second program code that allows the computer to execute processing of generating one-variable polynomials uₓ(t) and u_{y}(t) each having a degree d on a prime field based on the prime number p and the maximum degree d in the memory and generating the sections (uₓ(t),u_{y}(t),x) from the one-variable polynomials uₓ(t) and u_{y}(t);
third program code that allows the computer to execute processing of generating a term other than a constant term by randomly producing a coefficient of the term other than the constant term when the fibration X(x,y,t) is regarded as a polynomial of variables x and y if the fibration x(x,y,t) is a public key;
fourth program code that allows the computer to execute processing of giving a negative sign to an assignment result obtained by assigning the sections to the term other than the constant term to calculate the constant term and generating the fibration X(x,y,t) constituted of the term other than the constant term and the constant term;
fifth program code that allows the computer to execute processing of writing a basic format of a plaintext polynomial having a coefficient mᵢⱼₖ as a variable in the memory;
sixth program code that allows the computer to execute processing of assigning the sections to the basic format of the plaintext polynomial in the memory when generating a format of the plaintext polynomial in which a message m is embedded;
seventh program code that allows the computer to execute processing of sequencing variables mᵢⱼₖ obtained as a result of the assignment to generate a variable vector (m₀₀₀, m₀₀₁, . . . , mᵢⱼₖ, . . . );
eighth program code that allows the computer to execute processing of organizing one-variable polynomials m(uₓ(t),u_{y}(t),t) obtained as a result of the assignment in regard to t and extracting a polynomial having a coefficient mᵢⱼₖuₓ(t)ⁱu_{y}(t)^{j} of t;
ninth program code that allows the computer to execute processing of generating a coefficient matrix in such a manner that a product obtained from the variable vector (m₀₀₀, m₀₀₁, . . . , mᵢⱼₖ, . . . ) precisely becomes the coefficient mᵢⱼₖuₓ(t)ⁱu_{y}(t)^{j} of t;
tenth program code that allows the computer to execute processing of calculating a rank of the coefficient matrix;
eleventh program code that allows the computer to execute processing of setting variables mᵢⱼₖ of some of the one-variable polynomials m(uₓ(t),u_{y}(t),t) to constants when the rank is higher than a degree number of the variable vector; and
twelfth program code that allows the computer to execute processing of outputting a format of a three-variable polynomial m(x,y,t) corresponding to the one-variable polynomial m(uₓ(t),u_{y}(t),t) when the rank is equal to or lower than the degree number of the variable vector as a format of a plaintext polynomial.
